(19) United States
(12) Patent Application Publication
(10) Pub. No.: US 2017/0039683 A1
(43) Pub. Date: Feb. 9, 2017

(54) IMAGE PROCESSING APPARATUS, IMAGE PROCESSING METHOD, IMAGE PROCESSING SYSTEM, AND NON-TRANSITORY COMPUTER READABLE MEDIUM

(71) Applicant: FUJI XEROX CO., LTD., Tokyo (JP)

(72) Inventors: Takayuki YAMAMOTO, Kanagawa (JP); Makoto SASAKI, Kanagawa (JP)

(73) Assignee: FUJI XEROX CO., LTD., Tokyo (JP)

(21) Appl. No.: 15/051,763

(22) Filed: Feb. 24, 2016

(30) Foreign Application Priority Data
Aug. 6, 2015 (JP) 2015-156495

(51) Int. Cl. G06T 5/00; G06F 3/0484

(52) U.S. Cl. CPC G06T 5/002; G06F 3/04842; G06F 3/04845; G06T 2200/24

(57) ABSTRACT

An image processing apparatus includes a representative position generation unit, a region extraction unit, and a selection information acceptance unit. The representative position generation unit generates a representative position included in a region that is part of an image in accordance with a feature value indicating a feature of the image. The region extraction unit extracts, based on the representative position, plural regions as candidate regions each having a feature value similar to the feature value of the representative position. The selection information acceptance unit accepts, from a user, selection of at least one region from among the extracted plural regions.

### CROSS-REFERENCE TO RELATED APPLICATIONS

This application is based on and claims priority under 35 USC 119 from Japanese Patent Application No. 2015-156495 filed Aug. 6, 2015.

### BACKGROUND

(i) Technical Field

The present invention relates to an image processing apparatus, an image processing method, an image processing system, and a non-transitory computer readable medium.

(ii) Related Art

The rise of the popularity of digital tools such as digital cameras has recently led to an increase in the number of users who capture and view digital images. The rising popularity of smartphones and tablets has also promoted the need for more intuitive editing operations such as adjusting image quality. Such editing operations have been previously performed on personal computers (PCs). The editing operations may involve selecting a specific region from within an image. To this end, it is necessary to perform a process of extracting and segmenting the specific region from within the image.

### SUMMARY

According to an aspect of the invention, there is provided an image processing apparatus including a representative position generation unit, a region extraction unit, and a selection information acceptance unit. The representative position generation unit generates a representative position included in a region that is part of an image in accordance with a feature value indicating a feature of the image. The region extraction unit extracts, based on the representative position, plural regions as candidate regions each having a feature value similar to the feature value of the representative position. The selection information acceptance unit accepts, from a user, selection of at least one region from among the extracted plural regions.

### BRIEF DESCRIPTION OF THE DRAWINGS

Exemplary embodiments of the present invention will be described in detail based on the following figures, wherein:

FIG. 1 illustrates an example configuration of an image processing system according to exemplary embodiments of the present invention;

FIG. 2 is a block diagram illustrating an example functional configuration of an image processing apparatus according to first and second exemplary embodiments;

FIG. 3A illustrates extracted regions, and FIG. 3B illustrates representative positions of the extracted regions;

FIG. 4A is a conceptual diagram in a case where pixels are separated into two classes with a threshold as a boundary, and FIG. 4B illustrates separate distribution of seeds of the same class at plural positions in an image;

FIGS. 5A to 5C illustrate how extracted regions are segmented from the image illustrated in FIG. 3A by using a region growing method;

FIG. 6 illustrates a first example screen displayed on a display screen of a display device in order for a user to select an extracted region;

FIGS. 7A to 7D illustrate a second example screen displayed on the display screen of the display device in order for a user to select an extracted region;

FIG. 8 is a block diagram illustrating an example functional configuration of an image processing apparatus according to third and fourth exemplary embodiments;

FIGS. 9A to 9D illustrate segmentation results obtained when smoothing is performed by a pre-processing unit and when no smoothing is performed;

FIG. 10A is a conceptual diagram of a method for obtaining a degree of visual attention;

FIGS. 10B and 10C illustrate a method for obtaining an anisotropic component of an original image;

FIGS. 11A to 11C illustrate a region growing method of the related art;

FIG. 12 is a block diagram illustrating an example functional configuration of a region extraction unit according to the exemplary embodiments;

FIG. 13A illustrates an original image from which extracted regions are to be segmented, and FIG. 13B illustrates reference pixels;

FIG. 14 illustrates a first range;

FIG. 15 illustrates a result of determination based on a Euclidean distance for a target pixel within the first range illustrated in FIG. 14;

FIGS. 16A and 16B illustrate a method for determining a level of influence;

FIG. 17 illustrates a result of determination using a method based on strength for a target pixel within the first range illustrated in FIG. 14;

FIGS. 18A to 18H illustrate an example of the progress of how pixels are sequentially labeled by using a region growing method based on strength in a first example;

FIGS. 19A to 19H illustrate an example of the progress of how pixels are sequentially labeled by using a region growing method in a second example;

FIGS. 20A and 20B illustrate the case where the order of rows and columns is reversed;

FIG. 21 is a flowchart illustrating the operation of the region extraction unit in the first and second examples;

FIG. 22 illustrates a target pixel selected by a pixel selection unit and a second range set by a range setting unit in a third example;

FIG. 23 illustrates a result of determination according to the third example;

FIGS. 24A to 24H illustrate an example of the progress of how pixels are sequentially labeled by using a region growing method in a fourth example;

FIG. 25 is a flowchart illustrating the operation of the region extraction unit in the third and fourth examples;

FIG. 26 is a flowchart illustrating the operation of the region extraction unit in a fifth example;

FIGS. 27A and 27B are conceptual diagrams illustrating retinex processing for enhancing the visibility of an original image; and

FIG. 28 illustrates a hardware configuration of the image processing apparatus.

### DETAILED DESCRIPTION

Exemplary embodiments of the present invention will be described in detail hereinafter with reference to the accompanying drawings.

### Description of Overall Image Processing System

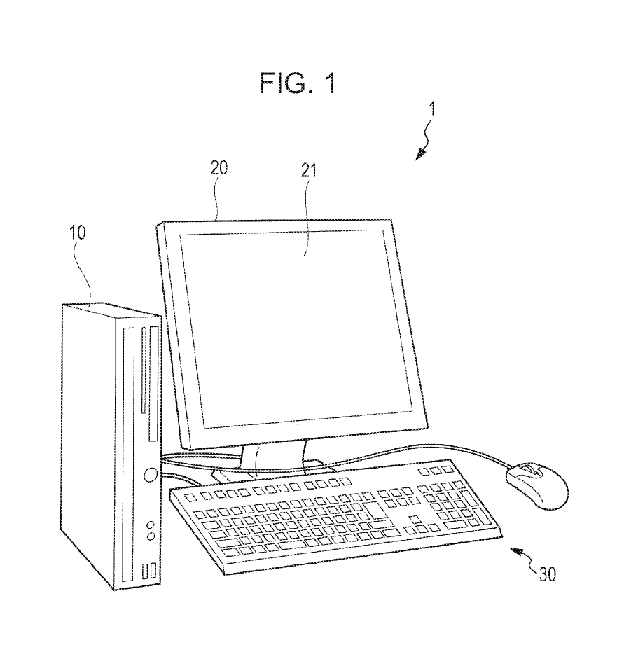

FIG. 1 illustrates an example configuration of an image processing system 1 according to the exemplary embodiments.

As illustrated in FIG. 1, the image processing system 1 according to the exemplary embodiments includes an image processing apparatus 10, a display device 20, and an input device 30. The image processing apparatus 10 performs image processing on image information on an image displayed on the display device 20. The display device 20 receives image information created by the image processing apparatus 10, and displays an image based on the image information. The input device 30 is operated by a user to input various kinds of information to the image processing apparatus 10.

The image processing apparatus 10 is a general-purpose personal computer (PC), for example. The image processing apparatus 10 causes various types of application software to operate under the management of an operating system (OS). Accordingly, operations, such as creating image information, are performed.

The display device 20 displays an image on a display screen 21. The display device 20 is implemented by a device having a function of displaying an image using additive color mixing, such as a PC liquid crystal display, a liquid crystal television (TV) monitor, or a projector. Thus, the display method of the display device 20 is not limited to a liquid crystal method. In the example illustrated in FIG. 1, the display device 20 includes the display screen 21. Alternatively, in a case where, for example, a projector is used as the display device 20, the display screen 21 may be a screen located outside the display device 20.

The input device 30 is constituted by a keyboard, a mouse, and other suitable components. The input device 30 may be used to activate or deactivate application software for image processing, or may be used by a user to input instructions to the image processing apparatus 10 to perform image processing when the user is to perform image processing, which will be described in detail below.

The image processing apparatus 10 and the display device 20 are connected to each other via a digital visual interface (DVI). Any other method instead of DVI, such as HDMI (registered trademark) (High-Definition Multimedia Interface) or DisplayPort connection, may be used.

The image processing apparatus 10 and the input device 30 are connected to each other via, for example, Universal Serial Bus (USB). Any other method instead of USB, such as Institute of Electrical and Electronics Engineers (IEEE) 1394 or RS-232C connection, may be used.

In the image processing system 1 having the configuration described above, an original image that is an image before image processing is first displayed on the display device 20. Then, as described in detail below, extracted regions that are candidates of a specific region to be subjected to image processing are automatically segmented by the image processing apparatus 10. The results of the segmentation of extracted regions are displayed on the display device 20, and the user selects one of the extracted regions on which the user wishes to perform image processing. Further, when the user inputs instructions to the image processing apparatus 10 to perform image processing, the image processing apparatus 10 performs image processing on image information on the original image. The user-performed operations described above are performed by the user by using the input device 30. The result of the image processing is reflected in the image displayed on the display device 20, and an image subjected to the image processing is re-rendered and is displayed on the display device 20. In this case, the user is able to interactively perform image processing while viewing the image on the display device 20. Accordingly, more intuitive and easier image processing operations may be achievable.

Note that the configuration of the image processing system 1 according to the exemplary embodiments is not limited to that illustrated in FIG. 1. For example, a tablet terminal may be exemplified as the image processing system 1. The tablet terminal has a touch panel on which an image is displayed and through which instructions given by a user are input. That is, the touch panel functions as the display device 20 and the input device 30. A touch monitor may also be used as an integrated device of the display device 20 and the input device 30. The touch monitor has a touch panel serving as the display screen 21 of the display device 20. In this case, image information is created by the image processing apparatus 10, and an image based on the image information is displayed on the touch monitor. By operating the touch monitor, such as touching the touch monitor, the user inputs instructions for performing image processing.

### Description of Image Processing Apparatus

### First Exemplary Embodiment

The image processing apparatus 10 will now be described. First, a description will be given of an image processing apparatus 10 according to a first exemplary embodiment.

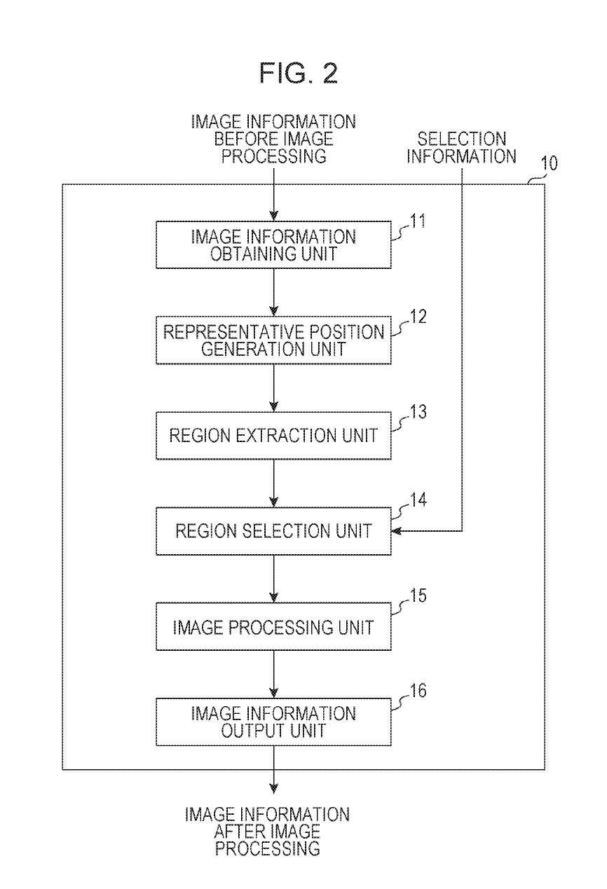

FIG. 2 is a block diagram illustrating an example functional configuration of the image processing apparatus 10 according to the first exemplary embodiment. In FIG. 2, functions related to this exemplary embodiment among the various functions of the image processing apparatus 10 are selectively illustrated.

As illustrated in FIG. 2, the image processing apparatus 10 according to this exemplary embodiment includes an image information obtaining unit 11, a representative position generation unit 12, a region extraction unit 13, a region selection unit 14, an image processing unit 15, and an image information output unit 16.

The image information obtaining unit 11 obtains image information on an image to be subjected to image processing. That is, the image information obtaining unit 11 obtains image information on the original image before image processing. The image information is represented by, for example, video data in Red-Green-Blue (RGB) form (RGB data) for display on the display device 20.

The representative position generation unit 12 generates a representative position included in a region that is part of the image in accordance with a feature value indicating a feature of the image. The representative position is generated as part of an extracted region. This point will be described hereinbelow.

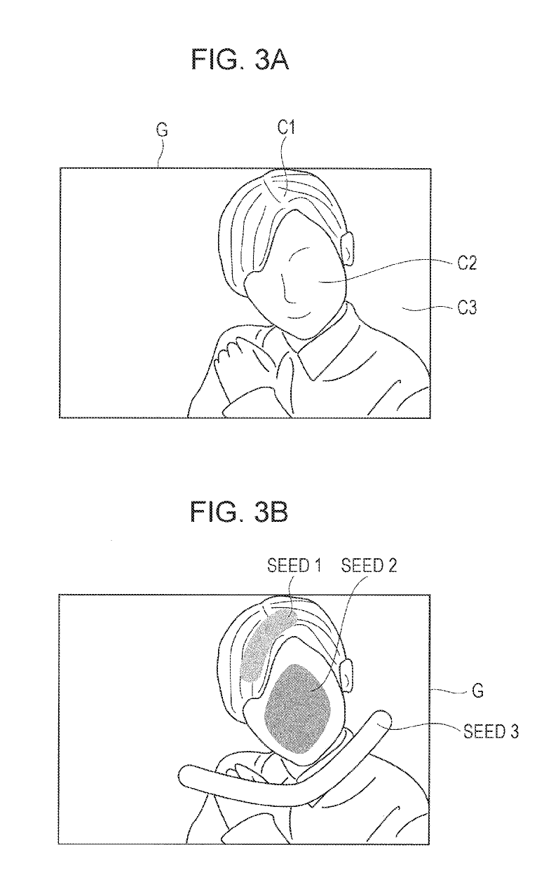

FIG. 3A illustrates extracted regions.

In FIG. 3A, an image displayed on the display screen 21 of the display device 20 is an image G of a photograph that shows a person in the foreground and a background behind the person. In this case, the image G is regarded as having, for example, three extracted regions, namely, the hair portion of the person's head in the foreground, the face portion of the person, and a non-hair and non-face portion of the person. In the following, these extracted regions may be referred to individually as an extracted region C1, an extracted region C2, and an extracted region C3. In this exemplary embodiment, furthermore, a region other than the extracted region C1, a region other than the extracted region C2, and a region other than the extracted region C3 are also regarded as extracted regions. In the following, these extracted regions may be referred to individually as an extracted region C1′, an extracted region C2′, and an extracted region C3′.

FIG. 3B illustrates representative positions of extracted regions.

As illustrated in FIG. 3B, a representative position is generated as part of an extracted region. In a case where the image G is an image constituted by the three extracted regions described above, three representative positions of these extracted regions are illustrated in FIG. 3B. In the following, the representative positions may be referred to as “seeds”. In FIG. 3B, the representative position of the hair portion of the person's head is represented by “seed 1”, the representative position of the face portion of the person is represented by “seed 2”, and the representative position of the non-hair and non-face portion of the person is represented by “seed 3”.

The representative position generation unit 12 generates a representative position (seed) in accordance with a feature value indicating a feature of the image.

In this exemplary embodiment, the magnitudes of the pixel values (RGB values) of pixels constituting the image G are used as feature values. Specifically, the representative position generation unit 12 generates a representative position by using clustering based on the magnitude of the pixel value (RGB value) of each pixel. This method will now be described in detail.

The representative position generation unit 12 creates a histogram for each of the pixel values (RGB values) of pixels constituting an original image. The representative position generation unit 12 then binarizes the respective pixels as follows. For example, a discriminant analysis method is employed to determine a threshold that maximizes the between-class variance. Then, for each of red (R), green (G), and blue (B), a pixel having a pixel value greater than or equal to the threshold is represented by 255 and a pixel having a pixel value less than the threshold is represented by 0. Accordingly, each pixel is binarized. As a result of the binarization, the pixels are classified into eight classes, i.e., (R, G, B)=(0, 0, 0), (255, 0, 0), (0, 255, 0), (0, 0, 255), (255, 255, 0), (0, 255, 255), (255, 0, 255), (255, 255, 255). Among them, a pixel included in a class having a large number of pixels is used as a seed. For example, pixels included in the top three classes having large numbers of pixels are represented by seed 1, seed 2, and seed 3.

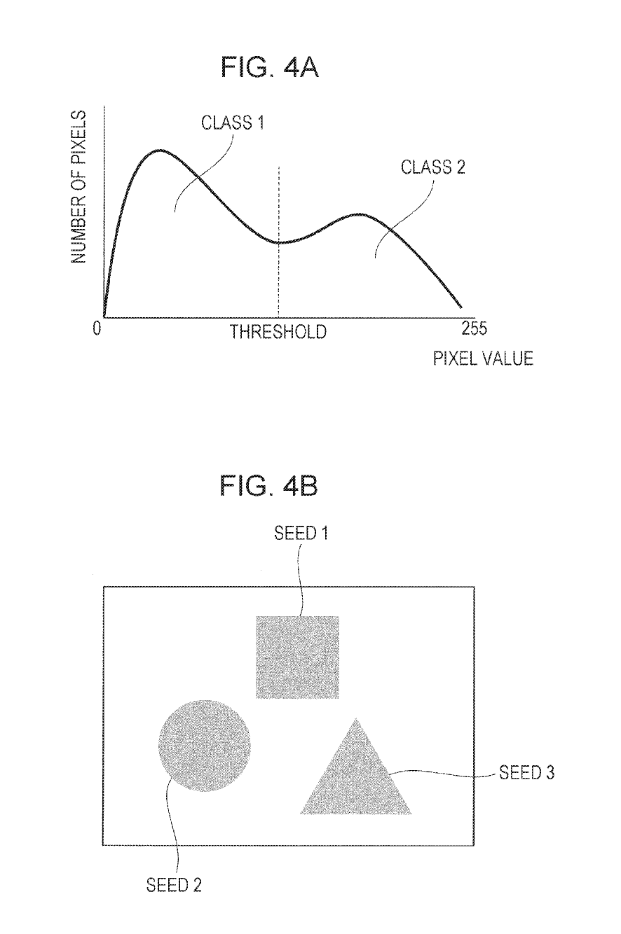

FIG. 4A is a conceptual diagram in a case where pixels are separated into two classes, or class 1 and class 2, with a threshold as a boundary.

In FIG. 4A, the horizontal axis represents pixel values, and the vertical axis represents the number of pixels. The class of pixels having pixel values less than the threshold is represented by class 1, and the class of pixels having pixel values greater than or equal to the threshold is represented by class 2.

The threshold is determined as follows.

The mean of all the pixel values is denoted by mₜ, and the variance is denoted by σₜ². In addition, the number of pixels in the class 1 is denoted by ω₁, the pixel value mean is denoted by m₁, and the variance is denoted by σ₁². Further, the number of pixels in the class 2 is denoted by ω₂, f the pixel value mean is denoted by m₂, and the variance is denoted by σ₂². In this case, the within-class variance σ_{w}² and the between-class variance σ_{b}² are respectively represented by equations (1) and (2) as follows.

$$\begin{matrix}{σ}_{w}^{2} = \frac{{ω}_{1} {σ}_{1}^{2} + {ω}_{2} {σ}_{2}^{2}}{{ω}_{1} + {ω}_{2}} & ( 1 ) \\ {σ}_{b}^{2} = \frac{{{ω}_{1} ( {m}_{t} - {m}_{1} )}^{2} + {{ω}_{2} ( {m}_{t} - {m}_{2} )}^{2}}{{ω}_{1} + {ω}_{2}} = \frac{{ω}_{1} {{ω}_{2} ( {m}_{1} - {m}_{2} )}^{2}}{{( {ω}_{1} + {ω}_{2} )}^{2}} & ( 2 )\end{matrix}$$

The variance of all the pixels is denoted by σₜ², which is represented by equation (3) as follows.

σₜ²=σ_{w}²+σ_{b}² (3)

The between-class separation t is represented by equation (4) below by using the ratio of the between-class variance σ_{b}² to the within-class variance σ_{w}².

$$t = \frac{{σ}_{b}^{2}}{{σ}_{w}^{2}} = \frac{{σ}_{b}^{2}}{{σ}_{t}^{2} - {σ}_{b}^{2}} \qquad ( 4 )$$

Since the variance σₜ² of all the pixels is constant, the separation t becomes maximum when the between-class variance σ_{b}² becomes maximum. Then, a threshold that maximizes the between-class variance σ_{b}² is determined.

After the pixels have been binarized, a pixel included in a class having a large number of pixels is used as a seed. For example, pixels included in the top three classes having large numbers of pixels are represented by seed 1, seed 2, and seed 3. Then, it is determined whether or not the pixel values of four or eight neighboring pixels around each pixel are in the same class as that of the pixel. If the pixel values of neighboring pixels around each pixel are in the same class as that of the pixel, these pixels are determined to be of the same seed. That is, clustering is performed based on the pixel values (RGB values) of pixels to generate a seed.

In a case where seeds of the same class are separately distributed over plural positions in the image, a process may be performed in which the seeds are handled as separate seeds. For example, an image has seed 1, seed 2, and seed 3 in a manner illustrated in FIG. 4B. In the illustrated image, even if the seed 1 and the seed 2 are classified into the class of (255, 255, 0), the seed 1 and the seed 2 are handled as separate seeds since they are uncombined, separate regions.

In the example described above, the pixel value of each pixel is converted into binary form, which is not limited thereto. The pixel value of each pixel may be converted into ternary or more multi-valued form.

The region extraction unit 13 extracts, based on a representative position (seed), multiple regions as candidate regions each having a feature value similar to the feature value of the representative position (seed). The region extraction unit 13 extracts multiples regions as regions each having a feature value similar to the feature value of the representative position (seed), and obtains extracted regions.

The region extraction unit 13 segments extracted regions by using a region growing method. In the region growing method, a pixel marked as a seed (hereinafter referred to as a “seed pixel”) and a neighboring pixel of the seed pixel are combined or not in accordance with how close the pixel values of the seed pixel and the neighboring pixel are to each other. More specifically, both pixels are combined if the pixel values are close to each other, and are not combined if the pixel values are far from each other. This operation is repeatedly performed. The details of the segmentation of extracted regions will be described below.

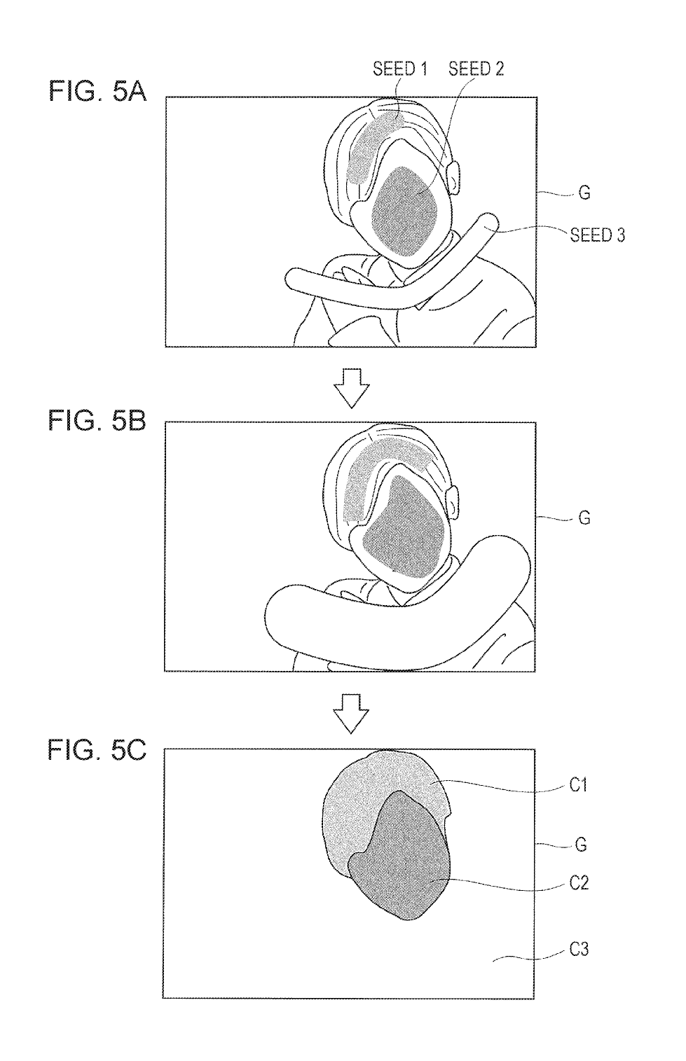

FIGS. 5A to 5C illustrate how extracted regions are segmented from the image G illustrated in FIG. 3A by using a region growing method.

FIG. 5A illustrates an image corresponding to the image G illustrated in FIG. 3B, in which the seed 1, the seed 2, and the seed 3 generated by the representative position generation unit 12 are illustrated.

Then, as illustrated in FIG. 5B, a region is grown into an extracted region, starting from a portion where a path is drawn as a seed. Finally, as illustrated in FIG. 5C, three extracted regions, namely, the extracted region C1, the extracted region C2, and the extracted region C3, are segmented as extracted regions.

The method described above allows the user to more intuitively and more easily segment extracted regions even if the extracted regions have complex shapes.

The region selection unit 14 performs a process of selecting at least one of the segmented extracted regions in accordance with instructions given by the user.

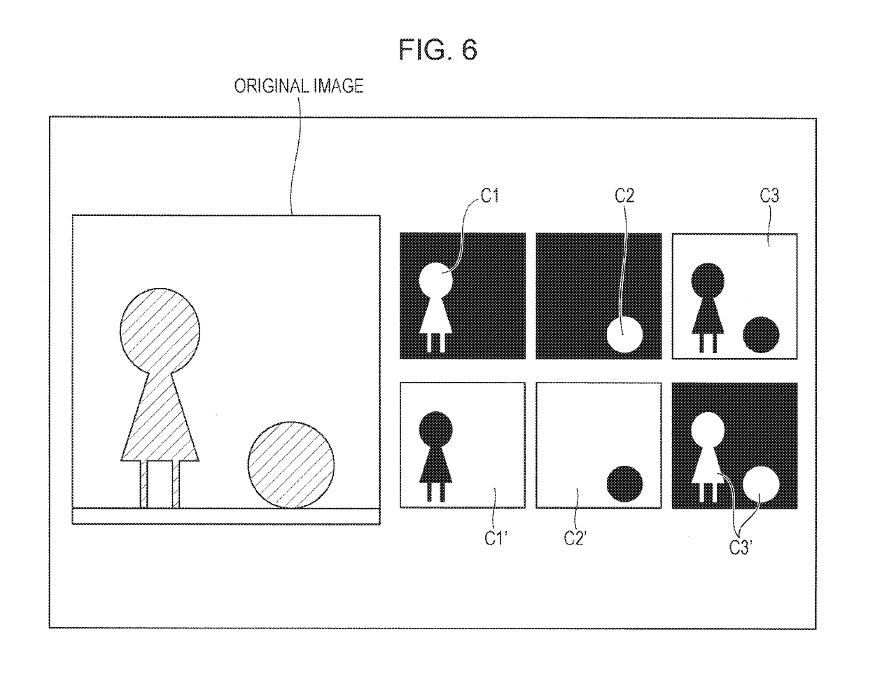

FIG. 6 illustrates a first example screen displayed on the display screen 21 of the display device 20 in order for a user to select an extracted region.

In the illustrated example, an original image is displayed in the left part of the display screen 21, and the results of segmentation of extracted regions are displayed in the right part of the display screen 21.

In this case, six regions, that is, an extracted region C1, an extracted region C2, an extracted region C3, an extracted region C1′, an extracted region C2′, and an extracted region C3′, are obtained as segmentation results. Thus, the six segmentation results are displayed.

The user is able to select one or more of the displayed extracted regions. When the user selects one extracted region from among the six segmentation results, the user regards the selected extracted region as having been selected. When the user selects multiple extracted regions, the user regards an extracted region that is the set of the selected extracted regions as having been selected.

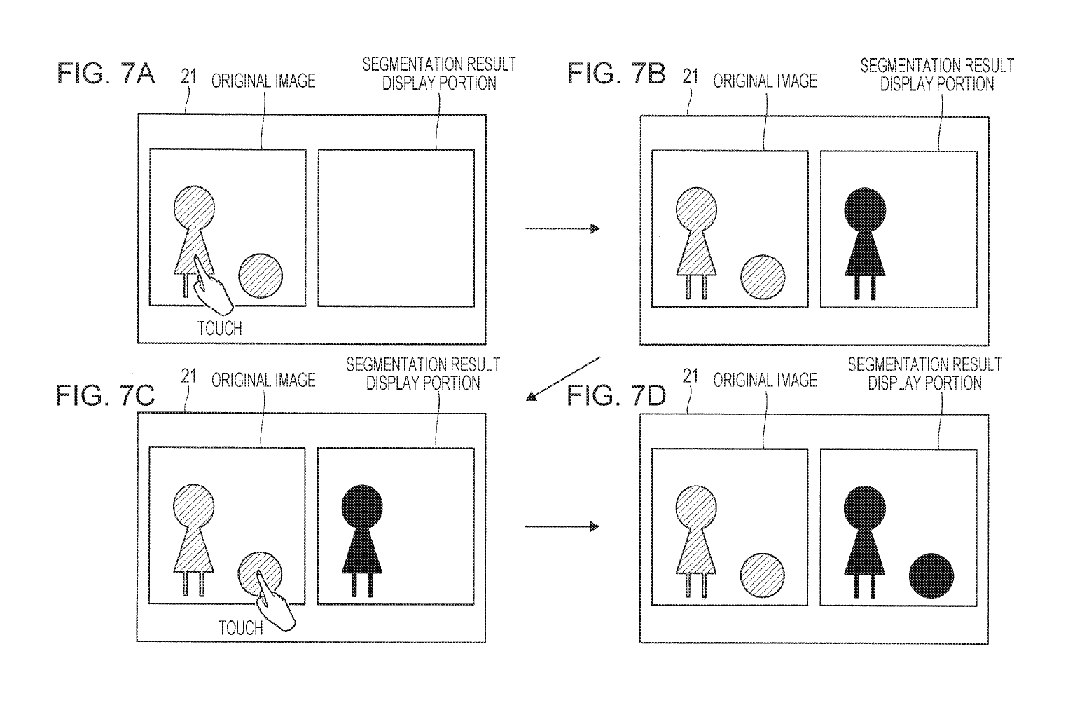

FIGS. 7A to 7D illustrate a second example screen displayed on the display screen 21 of the display device 20 in order for a user to select an extracted region.

FIG. 7A is a screen initially displayed on the display screen 21. As illustrated in FIG. 7A, an original image is displayed in the left part of the display screen 21. In FIG. 7A, a segmentation result display portion is further displayed in the right part of the display screen 21. In the state illustrated in FIG. 7A, no item is displayed in the segmentation result display portion. Note that the segmentation of extracted regions has been completed at the time when the illustrated screen is displayed.

When the user touches an object in the original image on the screen illustrated in FIG. 7A, as illustrated in FIG. 7B, an extracted region corresponding to the touched object is displayed in the segmentation result display portion.

When the user further touches another object in the original image on the screen illustrated in FIG. 7B in a manner illustrated in FIG. 7C, as illustrated in FIG. 7D, a region corresponding to the touched object is additionally displayed in the segmentation result display portion.

The region selection unit 14 accepts selection information that is information indicating the extracted region or regions selected by the user from among the extracted regions which have been extracted. Accordingly, the region selection unit 14 performs a process of selecting at least one of the extracted regions. It will thus be understandable that the region selection unit 14 is an example of a selection information acceptance unit configured to accept, from a user, selection of at least one region from among plural regions (extracted regions) which has been extracted.

The image processing unit 15 actually performs image processing on a selected extracted region.

The image processing unit 15 performs image processing on the selected extracted region, for example, adjusting the hue, saturation, and luminance.

In practice, for example, three slide bars for the adjustment of “hue”, “saturation”, and “luminance” are prepared in the lower part of the display screen 21. When the user slides a slider for any one of “hue”, “saturation”, and “luminance” along the corresponding one of the slide bars by using the input device 30, the image processing unit 15 obtains information on the operation performed by the user. Then, the image processing unit 15 performs image processing on the selected extracted region to change the corresponding attribute.

The image information output unit 16 outputs image information subjected to the image processing in the way described above. The image information subjected to the image processing is sent to the display device 20. Then, an image based on the image information is displayed on the display screen 21 of the display device 20.

In the example described above, a seed is generated for the entire original image, by way of example. Alternatively, for example, the user may roughly specify a region that is part of the original image and then perform a similar process. In addition, the representative position generation unit 12 performs clustering by using a technique based on the discriminant analysis method. Alternatively, any other typical clustering technique such as k-means or Gaussian mixture model (GMM) estimation may be used. Furthermore, the color space in which processing is performed is not limited to the RGB color space, and any other color space may be used. For example, the hue-saturation-value (HSV) color space, the Commission Internationale de l'Eclairage (CIE) L*a*b* color space, which is a perceptually uniform color space, or a color space that takes psychophysical vision into account, such as CIECAM02 or iCAM, may be used.

In the example described above, furthermore, a seed is generated based on the entire image. As an alternative example, after the user specifies a rough region, a seed may be generated within the specified region.

### Second Exemplary Embodiment

Next, an image processing apparatus 10 according to a second exemplary embodiment of will be described.

An example functional configuration of the image processing apparatus 10 according to the second exemplary embodiment is similar to that illustrated in FIG. 2.

In the second exemplary embodiment, the operation of the representative position generation unit 12 is different from that in the first exemplary embodiment while the operation of the other functional units is substantially the same as that in the first exemplary embodiment. Thus, the following description is made mainly of the operation of the representative position generation unit 12.

In this exemplary embodiment, the Euclidean distance between the pixel value (RGB value) of each of pixels constituting an image G and a predetermined color parameter is used as a feature value. The Euclidean distance is a color difference in the RGB color space. How close the pixel value of each pixel is to the color parameter is determined to generate a representative position (seed).

First, the representative position generation unit 12 normalizes the pixel values of the respective pixels to a range of 0 to 1. The normalized pixel value of a pixel at a position (i, j) is represented by (R, G, B)=(r_{i,j}, g_{i,j}, b_{i,j}). Further, (rₜ, gₜ, bₜ) is set as a color parameter.

In this case, the Euclidean distance L_{i,j} between the pixel value of each pixel and the predetermined color parameter is determined by using equation (5) as follows.

L_{i,j}=\sqrt{(r_{i,j}−rₜ)²+(g_{i,j}−gₜ)²+(b_{i,j}−bₜ)²} (5)

If the Euclidean distance L_{i,j} is smaller than a predetermined threshold T1 (L_{i,j}<T1), the corresponding pixel is determined to be a seed pixel. Three types of thresholds T1, which are equal to, for example, 0.1, 0.2, and 0.3, are used. A seed is generated for each of the three types of thresholds T1. In this case, therefore, three seeds are generated.

Similarly, if the Euclidean distance L_{i,j} is larger than a predetermined threshold T2 (L_{i,j}>T2), the corresponding pixel is determined to be a seed pixel. The threshold T2 is equal to, for example, 0.9.

Based on the seeds, the region extraction unit 13 extracts regions from within the image. Since the representative position generation unit 12 generates a seed for each of the three types of thresholds T1, a different segmentation result for each of the respective types of thresholds T1 is obtained. The user selects the desired segmentation result from among the segmentation results. The pixel value of a designated object color may be different than expected depending on the subject imaging conditions and other factors. Thus, using multiple thresholds T1 and allowing a user to select one of them may yield a robust system.

In this exemplary embodiment, seeds are calculated by using a color difference, which may cause an object other than the desired one to be included in segmentation results if unnecessary objects of the same color exist. To address this situation, a mode in which seeds are directly editable may be provided to enable a user to directly remove a seed in an unnecessary object.

In the example described above, a single color is specified as a color parameter. Alternatively, multiple colors may be specified or only the luminance value may be specified. For instance, two colors, namely, C₁(rₜ₁, gₜ₁, bₜ₁) and C₂(rₜ₂, gₜ₂, bₜ₂), are set as color parameters.

The Euclidean distances L1_{i,j} and L2_{i,j} between the normalized pixel value of a pixel at a position (i, j) and the color parameters described above are determined by using equations (6) and (7) as follows.

L1_{i,j}=\sqrt{(r_{i,j}−rₜ₁)²+(g_{i,j}−gₜ₁)²+(b_{i,j}−bₜ₁)²} (6)

L2_{i,j}=\sqrt{(r_{i,j}−rₜ₂)²+(g_{i,j}−gₜ₂)²+(b_{i,j}−bₜ₂)²} (7)

If the Euclidean distance L1_{i,j} or the Euclidean distance L2_{i,j} is smaller than a predetermined threshold T1 (L1_{i,j}<T1 or L2_{i,j}<T1), the corresponding pixel is determined to be a seed pixel.

Similarly, if both the Euclidean distance L1_{i,j} and the Euclidean distance L2_{i,j} are larger than a predetermined threshold T2 (L1_{i,j}>T2 and L2_{i,j}>T2), the corresponding pixel is determined to be a seed pixel.

In this case, a large number of types of segmentation results are obtained. Thus, the display of segmentation results in the manner illustrated in FIG. 6 may be performed stepwise. For example, when a user selects any one of “color C₁”, “color C₂”, and “both colors”, segmentation results for the corresponding color parameter are displayed.

### Third Exemplary Embodiment

Next, an image processing apparatus 10 according to a third exemplary embodiment will be described.

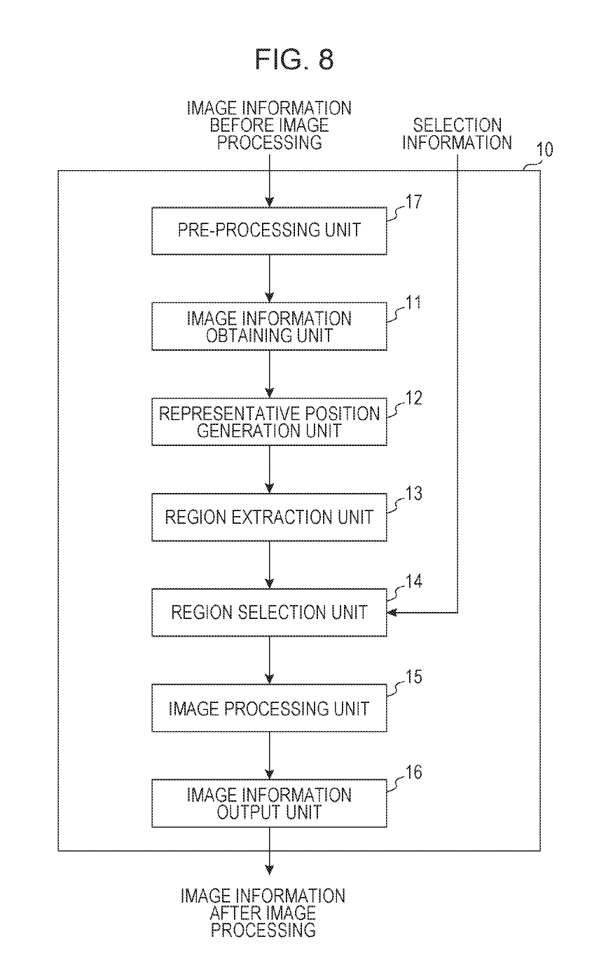

FIG. 8 is a block diagram illustrating an example functional configuration of the image processing apparatus 10 according to the third exemplary embodiment.

As illustrated in FIG. 8, the image processing apparatus 10 according to this exemplary embodiment is different from the image processing apparatus 10 illustrated in FIG. 2 in that a pre-processing unit 17 is further included. The operation of the functional units other than the pre-processing unit 17 is substantially the same as that of the image processing apparatus 10 illustrated in FIG. 2. Thus, the following description is made mainly of the operation of the pre-processing unit 17.

The pre-processing unit 17 performs a smoothing process for smoothing an original image by using a Gaussian filter. Specifically, the pre-processing unit 17 performs a convolution operation on the original image by using a filter with a Gaussian distribution defined in, for example, equation (8) below. Accordingly, a smoothed image is obtained as a result of smoothing the original image. In the subsequent operation, the representative position generation unit 12 generates representative positions (seeds) from the smoothed image obtained by the pre-processing unit 17, by using the method described in the first exemplary embodiment or the second exemplary embodiment, and the region extraction unit 13 extracts regions based on the seeds.

$$f ( x , y ) = \frac{1}{2 π {σ}^{2}} exp ( - \frac{{x}^{2} + {y}^{2}}{2 {σ}^{2}} ) \qquad ( 8 )$$

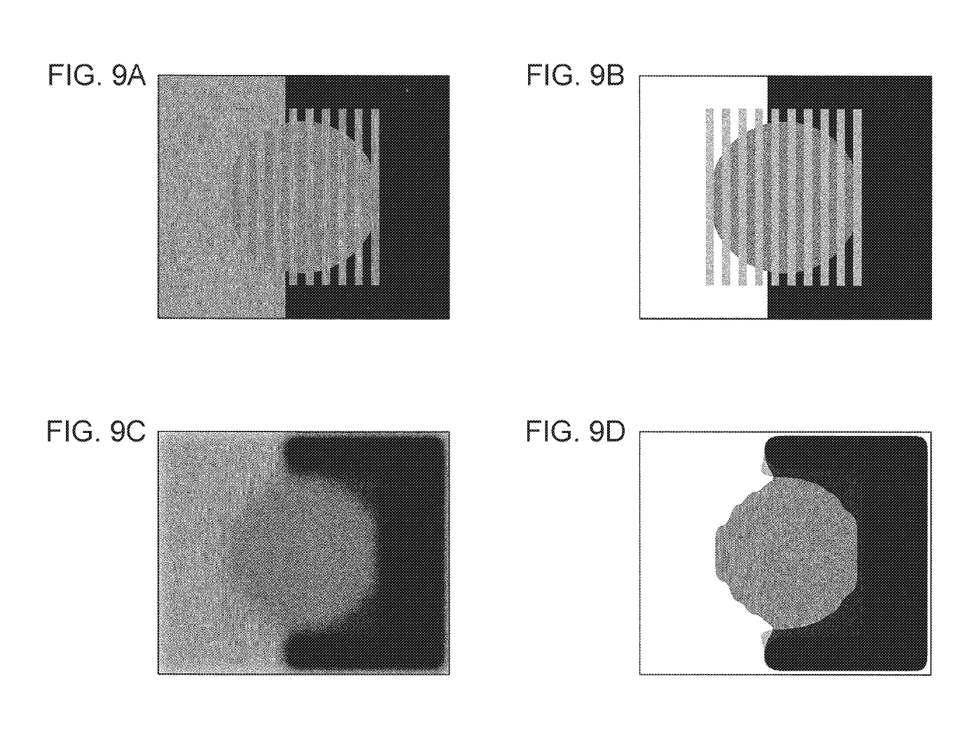

FIGS. 9A to 9D illustrate segmentation results obtained when smoothing is performed by the pre-processing unit 17 and when no smoothing is performed.

FIG. 9A illustrates an original image.

As a result of segmentation of extracted regions from the original image by using the method described in the first exemplary embodiment or the second exemplary embodiment, a screen illustrated in FIG. 9B is obtained. As illustrated in FIG. 9B, regions in the original image are directly extracted.

In contrast, FIG. 9C illustrates a smoothed image obtained by smoothing the original image by using the pre-processing unit 17. As illustrated in FIG. 9C, as a result of smoothing, an entirely blurred image is obtained. In the subsequent operation, extracted regions are segmented by using the method described in the first exemplary embodiment, resulting in a screen illustrated in FIG. 9D. As illustrated in FIG. 9D, segmentation results different from those illustrated in FIG. 9B are obtained.

Accordingly, with the use of a smoothed image for the generation of seeds, even regions more sensitive to the high-frequency components and more likely to undergo changes in color are treated as being in the same class. This may simplify a procedure for selecting a feature value on which a seed is based.

The process performed by the pre-processing unit 17 is not limited to a smoothing process.

For example, the pre-processing unit 17 performs a band division process for dividing an original image into bands. In the smoothing process, the high-frequency components of the original image are removed. In order to use the high-frequency components, a high-frequency component image is created by using the difference between the original image and the smoothed image, a difference of Gaussian (DoG) filter, or the like. In this case, the pre-processing unit 17 performs a band division process to create a high-frequency component image. In the subsequent operation, the representative position generation unit 12 generates representative positions (seeds) from the high-frequency component image processed by the pre-processing unit 17, by using the method described in the first exemplary embodiment or the second exemplary embodiment, and the region extraction unit 13 extracts regions based on the seeds.

The extraction of regions based on a high-frequency component image is effective particularly for the segmentation of multiple thin objects, such as branches of a tree, from an image.

In a case where the pre-processing unit 17 performs a smoothing process, the pre-processing unit 17 may be regarded as serving as an image smoothing unit. In a case where the pre-processing unit 17 performs a band division process, the pre-processing unit 17 may be regarded as serving as a band division unit.

### Fourth Exemplary Embodiment

Next, an image processing apparatus 10 according to a fourth exemplary embodiment will be described.

An example functional configuration of the image processing apparatus 10 according to the fourth exemplary embodiment is similar to that illustrated in FIG. 8.

In the fourth exemplary embodiment, the operation of the representative position generation unit 12 is different from that in the third exemplary embodiment while the operation of the other functional units is substantially the same as that in the third exemplary embodiment. Thus, the following description is made mainly of the operation of the representative position generation unit 12.

In this exemplary embodiment, a degree of visual attention is used as a feature value. The representative position generation unit 12 calculates, for each pixel or each predetermined region, the degree (degree of visual attention) to which the pixel or region is likely to attract attention from people, from either or both of the original image and the smoothed image, and uses the degree of visual attention as a feature value.

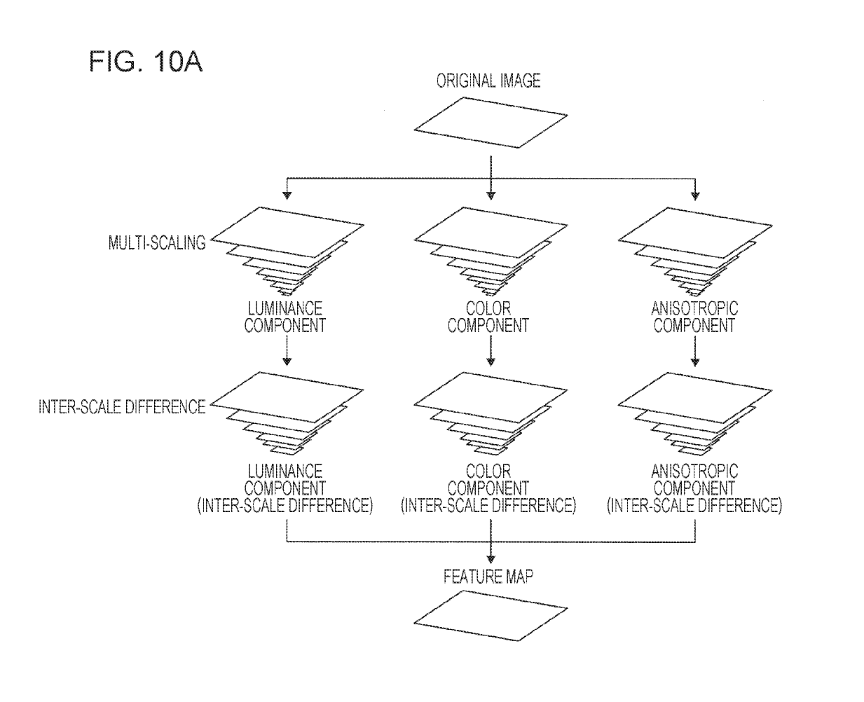

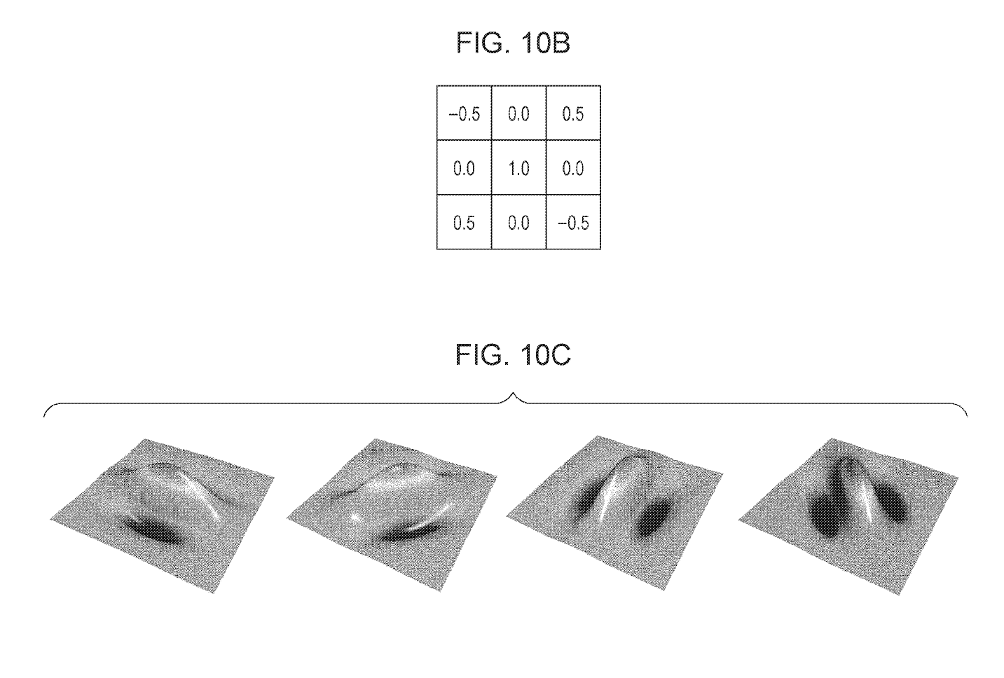

FIG. 10A is a conceptual diagram of a method for obtaining a degree of visual attention.

First, a luminance component, a color component, and an anisotropic component (gradient information of a pixel value) are obtained from the original image and are repeatedly subjected to a convolution operation with a Gaussian filter and a sampling process for multi-scaling. The resulting images are referred to as feature images.

FIGS. 10B and 10C illustrate a method for obtaining an anisotropic component of an original image.

First, a filter with a directional distribution, such as that illustrated in FIG. 10B, is assumed. Such a filter is used to perform a convolution operation on each pixel of the original image. As a result, the influence of positive values of pixels in the upper right and lower left corners with respect to a target pixel at the center of the original image and negative values of pixels in the lower right and upper left corners with respect to the target pixel yields a large value at the position of the target pixel as a result of calculation, particularly in the presence of an outline from the upper right side to the lower left side. The convolution operation using such a filter with a directional distribution yields a directional component.

Examples of the filter with such a distribution include a Gabor Filter. With the Gabor Filter, gradient information of pixels surrounding the pixel of interest is obtained. The Gabor Filter is defined in equation (9) as follows.

g(x,y)=s(x,y)wᵣ(x,y) (9)

In equation (9), s(x, y) and wᵣ(x, y) are the sine wave and Gaussian function defined in equation (10) as follows, respectively.

s(xᵣ,yᵣ)=exp(i2π(u₀xᵣ+v₀yᵣ))

w(xᵣ,yᵣ)=K*exp(−π(a²xᵣ²+b²yᵣ²)) (10)

where xᵣ and yᵣ are represented by equation (11) below. In equation (10), a, b, u₀, and v₀ are constants for the sensitivity of the filter.

xᵣ=x cos θ+y sin θ

yᵣ=−x sin θ+y cos θ (11)

In equation (11), θ is a parameter for controlling the orientation of the filter, and the rotation of θ in π/4 increments yields a filter whose schematic shapes are illustrated in FIG. 10C.

The filters with four orientations are used to perform a convolution operation for each angle in accordance with equation (12) below to obtain I_{θ}(x, y). The results are used as directional components respectively for the four orientations.

I_{θ}(x,y)=I(x,y)*g(x,y,θ) (12)

In particular, the Gabor function is said to simulate the process of the human visual system. The use of the Gabor function enables the detection of directional components with accuracy similar to that for the visual system. While the use of the Gabor function to obtain only directional components has been described, the Gabor function may be replaced with a function which exhibits a similar shape and is said to be similar to the process of the human visual system, such as Laplacian Gaussian function.

Next, the individual feature images are enlarged to the same size, and differences of the respective corresponding pixels are calculated to calculate an inter-scale difference map of the feature images. This enhances the feature strength of a portion having different feature points between scales. This calculation simulates the difference in the Center-Surround stimulus to the cells in the human visual system, which yields a correlation with how likely people are to pay attention to pixels. Finally, the values of these features are normalized and the mean of the normalized feature values is calculated for each pixel, resulting in a feature map indicating a degree of visual attention. The feature map is an image in which the feature strength at each position in the field of vision (the degree to which people are likely to pay attention to the position (i.e., the degree of visual attention)) is represented by a pixel value.

The representative position generation unit 12 generates seeds by using the degrees of visual attention obtained in the way described above. For example, the representative position generation unit 12 normalizes each pixel constituting the feature map to a value from 0 to 1. Then, a pixel having a value from 0 to 0.1 is set as seed 1, and a pixel having a value from 0.9 to 1 is set as seed 2. The region extraction unit 13 then extracts regions based on the seed 1 and the seed 2.

### Description of Region Extraction Unit

Next, a method by which the region extraction unit 13 segments extracted regions by using a region growing method will be described in more detail.

First, a description will be given of a region growing method of the related art.

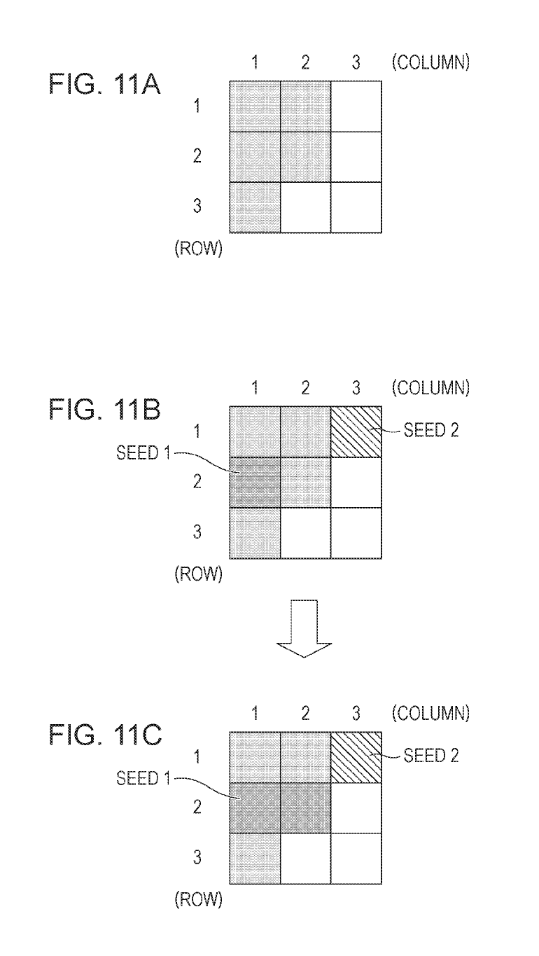

FIGS. 11A to 11C illustrate a region growing method of the related art.

FIG. 11A illustrates an original image made up of regions of 3 pixels vertically and 3 pixels horizontally, that is, 9 pixels (3×3=9). The original image is constituted by two image regions. In FIG. 11A, the two image regions are represented by using pixels with different intensities of a color. It is assumed that the pixels included in each image region have pixel values that are close to each other.

As illustrated in FIG. 11B, the pixel at the second row and first column is assigned seed 1, and the pixel at the first row and third column is assigned seed 2.

Now, consideration is given to the determination of whether or not the pixel at the second row and second column, which is the pixel at the center of the image (hereinafter referred to as the “center pixel”), belongs to an extracted region including the pixel assigned seed 1 or whether or not the center pixel belongs to an extracted region including the pixel assigned seed 2. Here, a comparison is made between the pixel value of the center pixel and the pixel value of a seed pixel included in the eight neighboring pixels of the center pixel. If both pixel values are close to each other, it is determined that the center pixel is included in the extracted region including the seed pixel. In the illustrated example, two seed pixels, namely, the pixel assigned seed 1 and the pixel assigned seed 2, are included in the eight neighboring pixels. Since the pixel value of the center pixel is closer to the pixel value of the pixel assigned seed 1 than to the pixel value of the pixel assigned seed 2, it is determined that the center pixel belongs to the extracted region including the pixel assigned seed 1.

Then, as illustrated in FIG. 11C, the center pixel belongs to the region including the pixel assigned seed 1. The center pixel is now handled as a new seed. In this case, the center pixel is labeled with “label 1”, which is the same as the label of the pixel assigned seed 1.

Then, as illustrated in FIG. 11C, the center pixel belongs to the region including the pixel assigned seed 1. The center pixel is now handled as a new seed. In this case, the center pixel is labeled with “label 1”, which is the same as the label of the pixel assigned seed 1.

In the region growing method of the related art, a pixel adjacent to a seed pixel is selected as a target pixel (in the example described above, the center pixel) to be determined to be or not to be in the corresponding extracted region, and the pixel value of the target pixel is compared with the pixel value of a seed pixel included in the eight neighboring pixels of the target pixel. The target pixel is considered to belong to a region including a seed pixel whose pixel value is close to the pixel value of the target pixel, and is labeled. The operation described above is repeatedly performed to expand the region.

A typical example of the region growing method of the related art is a Grow-Cut method described in the following article: V. Vezhnevets and V. Konouchine: “Grow-Cut”-Interactive Multi-label N-D Image Segmentation”, Proc. Graphicon. pp 150-156 (2005).

In the region growing method of the related art, as described above, focus is placed on a target pixel and the pixel value of the target pixel is compared with the pixel value of a seed pixel among the eight neighboring pixels of the target pixel to determine an extracted region to which the target pixel belongs. That is, the region growing method of the related art is a so-called “passive type” method in which the target pixel changes upon being influenced by the eight neighboring pixels.

In the exemplary embodiments, in contrast, the region extraction unit 13 has the following configuration.

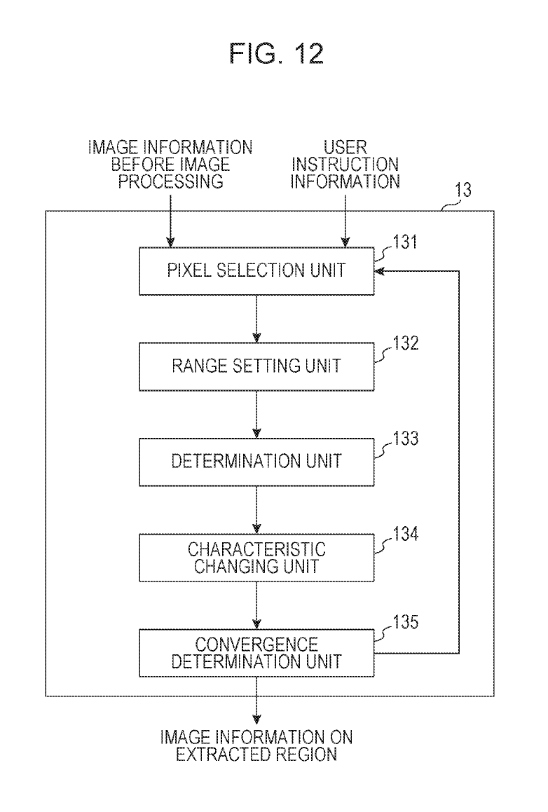

FIG. 12 is a block diagram illustrating an example functional configuration of the region extraction unit 13 according to the exemplary embodiments.

As illustrated in FIG. 12, the region extraction unit 13 according to this exemplary embodiment includes a pixel selection unit 131, a range setting unit 132, a determination unit 133, a characteristic changing unit 134, and a convergence determination unit 135.

In the following, the region extraction unit 13 illustrated in FIG. 12 will be described using first to fourth examples.

### First Example (in the Case of “Active Type” and “Synchronous Type”)

First, a description will be given of a first example of the region extraction unit 13.

In the first example, the pixel selection unit 131 selects a reference pixel. The reference pixel is selected from among pixels belonging to an extracted region. The term “pixels belonging to an extracted region” refers to pixels included in, for example, a representative position specified by a user, that is, seed pixels described above. The term “pixels belonging to an extracted region” is used to also include pixels which are newly labeled by using a region growing method.

Here, the pixel selection unit 131 selects one pixel as a reference pixel from among pixels belonging to an extracted region.

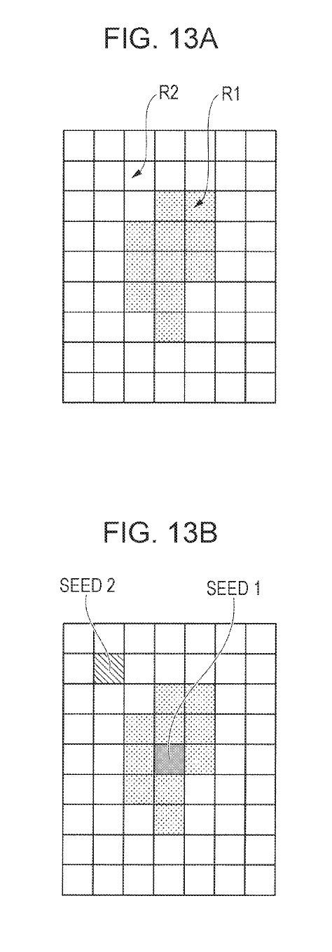

FIG. 13A illustrates an original image from which extracted regions are to be segmented. As illustrated in FIG. 13A, the original image is made up of regions of 9 pixels vertically and 7 pixels horizontally, that is, 63 pixels (9×7=63). As illustrated in FIG. 13A, the original image includes an image region R1 and an image region R2. The pixels included in the image region R1 have pixel values that are close to each other, and the pixels included in the image region R2 have pixel values that are close to each other. As described below, the image region R1 and the image region R2 are segmented as extracted regions.

For simplicity of illustration, as illustrated in FIG. 13B, the user designates two representative positions each in one of the image region R1 and the image region R2. Each of the representative positions is specified by a single pixel, and is selected as a reference pixel by the pixel selection unit 131. In FIG. 13B, the reference pixels are represented by seed 1 and seed 2.

Each of the pixels with seed 1 and seed 2 is labeled and has a strength, which will be described in detail below. Here, the pixels with seed 1 and seed 2 are labeled with label 1 and label 2, respectively, and have strengths which are both set to 1 as the initial value.

The range setting unit 132 sets a first range. The first range is set for a reference pixel, and is a specific range around the reference pixel. The specific range around the reference pixel is any specified range including at least one pixel among eight pixels adjacent to the reference pixel and the reference pixel.

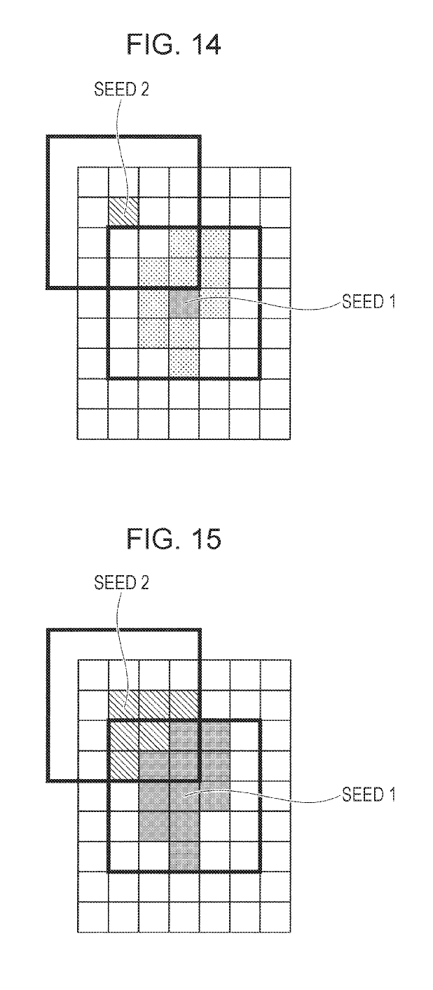

FIG. 14 illustrates the first range.

As illustrated in FIG. 14, the pixels with seed 1 and seed 2, which are reference pixels, are selected in the image region R1 and the image region R2, respectively. In addition, ranges of 5 pixels vertically and 5 pixels horizontally centered respectively on the pixels with seed 1 and seed 2 are set as first ranges. In FIG. 14, the first ranges are displayed as ranges defined by thick-line frames.

In this exemplary embodiment, the first ranges are variable, and may be reduced in accordance with the progress of the process, which will be described in detail below.

The determination unit 133 determines to which extracted region a target pixel (first target pixel) within a first range belongs. That is, the determination unit 133 determines whether or not each of the pixels included in a first range belongs to an extracted region to which a reference pixel belongs.

The determination unit 133 sets each of the 24 pixels, except for the pixels with seed 1 or seed 2, among the 25 pixels included in the first range as a target pixel (first target pixel) to be determined to be or not to be in the corresponding extracted region. Then, the determination unit 133 determines whether or not each of the target pixels is included in the extracted region (the extracted region C1) to which the pixel with seed 1 belongs, or/and determines whether or not each of the target pixels is included in the extracted region (the extracted region C2) to which the pixel with seed 2 belongs.

In this case, the determination may be based on the degree of closeness of pixel values.

Specifically, the 24 pixels included in the first range are assigned numbers, for convenience, and, assuming the i-th (where i is an integer from 1 to 24) target pixel is represented by Pᵢ, the color data of the pixel Pᵢ is represented by Pᵢ=(Rᵢ, Gᵢ, Bᵢ) if the color data is RGB data. Also, assuming that the reference pixel with seed 1 or seed 2 is represented by P₀, the color data of the reference pixel P₀ is represented by P₀=(R₀, G₀, B₀). To measure the degree of closeness of pixel values, the Euclidean distance dᵢ between the RGB values, which is given by equation (13) below, is considered.

dᵢ=\sqrt{(Rᵢ−Rₒ)²+(Gᵢ−Gₒ)²+(Bᵢ−Bₒ)²} (13)

If the Euclidean distance dᵢ is less than or equal to a predetermined threshold, the determination unit 133 determines that the target pixel Pᵢ belongs to the extracted region C1 or the extracted region C2. That is, if the Euclidean distance dᵢ is less than or equal to the predetermined threshold, the pixel value of the reference pixel P₀ and the pixel value of the target pixel Pᵢ are considered to be close to each other. In this case, the determination unit 133 determines that the reference pixel P₀ and the target pixel Pᵢ belong to the same extracted region.

In some cases, the Euclidean distances dᵢ for both the pixels with seed 1 and seed 2 may be less than or equal to the threshold. In such cases, the determination unit 133 determines that the target pixel Pᵢ belongs to the extracted region to which one of the pixels with seed 1 and seed 2 for which the Euclidean distance dᵢ is smaller belongs.

FIG. 15 illustrates a result of determination based on the Euclidean distance dᵢ for a target pixel within the first range illustrated in FIG. 14.

In FIG. 15, pixels in black, which is the same color as that of the pixel with seed 1, are determined to belong to the extracted region C1, and pixels with (diagonal) hatching, which is the same as that of the pixel with seed 2, are determined to belong to the extracted region C2. Pixels in white are determined to belong to none of the extracted regions C1 and C2.

Operating the determination unit 133 in the way described above provides an effect of allowing a given seed to be automatically spread out. In the exemplary embodiments, for example, the determination unit 133 may perform the operation described above only for the first time. Alternatively, the determination unit 133 may perform the operation described above for the first several times. In this case, in the subsequent operation, the determination unit 133 may perform the determination by using the “strength” described below. Note that the determination unit 133 may perform the determination by using the “strength” described below from the first time.

In the example described above, the description has been made in the context of the color data being RGB data. This is not intended to be limiting, and color data in any other color space, such as L*a*b* data, YCbCr data, HSV data, or IPT data, may be used. Not all the color components may be used. For example, when HSV data is used as color data, only the values of hue (H) and saturation (S) may be used.

In some cases, it may be desirable to use color data in any other color space to address the failure of segmentation of extracted regions. For example, consideration is given to the use of a Euclidean distance dᵢ^{w} that uses YCbCr values, which is given in equation (14) below, instead of the Euclidean distance dᵢ of the RGB values given by equation (13). Equation (14) provides the Euclidean distance dᵢ^{w} when the color data of the target pixel Pᵢ is represented by Pᵢ=(Yᵢ, Cbᵢ, Crᵢ) and the color data of the reference pixel P₀ is represented by P₀=(Y₀, Cb₀, Cr₀). Further, the Euclidean distance dᵢ^{w} given by equation (14) is a weighted Euclidean distance using weighting factors W_{Y}, W_{Cb}, and W_{Cr}. Equation (14) is effective when, for example, the difference in luminance between extracted regions is large but the difference in chromaticity is small. That is, the weighting factor W_{Y} is reduced to reduce the contribution of the luminance component Y to the Euclidean distance dᵢ^{w}. This results in a relative increase in the contribution of the chromaticity component to the Euclidean distance dᵢ^{w}. Consequently, the accuracy of segmentation of extracted regions between which the difference in luminance is large but the difference in chromaticity is small may be improved.

dᵢ^{w}=\sqrt{w_{Y}(Yᵢ−Yₒ)²+w_{Cb}(Cbᵢ−Cbₒ)²+w_{Cr}(Crᵢ−Crₒ)²} (14)

The color data to be used is not limited to color data having three components. For example, an n-dimensional color space may be used and a Euclidean distance dᵢ^{w} of n color components may be considered.

For example, equation (15) uses color components X₁, X₂, . . . , and Xₙ. Equation (15) provides a Euclidean distance dᵢ^{w} when the color data of the target pixel Pᵢ is represented by Pᵢ=(X₁ᵢ, X₂ᵢ, . . . , Xₙᵢ) and the color data of the reference pixel P₀ is represented by P₀=(X₁₀, X₂₀, . . . , Xₙ₀). The Euclidean distance dᵢ^{w} given by equation (15) is also a weighted Euclidean distance using weighting factors W_{X1}, W_{X2}, . . . , and W_{Xn}. In this case, the weighting factor for a color component which well exhibits the characteristics of an extracted region among the n color components is made relatively larger than the other weighting factors, enabling an improvement in the accuracy of segmentation of extracted regions.

$${d}_{i}^{w} = \sqrt{{{w}_{X 1} ( {X}_{1 i} - {X}_{1 o} )}^{2} + {{w}_{X 2} ( {X}_{2 i} - {X}_{2 o} )}^{2} + … + {{w}_{Xn} ( {X}_{ni} - {X}_{no} )}^{2}} \qquad ( 15 )$$

The characteristic changing unit 134 changes characteristics given to the target pixel (first target pixel) within the first range.

The term “characteristics”, as used herein, refers to the label and strength given to the target pixel.

The label indicates, as described above, to which extracted region the target pixel belongs, and a pixel belonging to the extracted region C1 is assigned “label 1” while a pixel belonging to the extracted region C2 is assigned “label 2”. Since the pixel with seed 1 has label 1 and the pixel with seed 2 has label 2, a pixel determined by the determination unit 133 to belong to the extracted region C1 (in FIG. 15, a pixel in black) is labeled with label 1. A pixel determined by the determination unit 133 to belong to the extracted region C2 (in FIG. 15, a pixel with (diagonal) hatching) is labeled with label 2.

The strength is a strength of a pixel belonging to the extracted region corresponding to the label assigned thereto, and indicates how likely it is that a certain pixel may belong to the extracted region corresponding to the label assigned thereto. The higher the strength, the more likely it is that the pixel may belong to the extracted region corresponding to the label. The lower the strength, the less likely it is that the pixel may belong to the extracted region corresponding to the label. The strength is determined in the following way.

First, the strength of a pixel included in a representative position specified by the user for the first time is set to 1 as the initial value. That is, a pixel with seed 1 or seed 2 before region growing has a strength of 1. An unlabeled pixel has a strength of 0.

Consideration is now given to the level of influence of a pixel given a strength on neighboring pixels.

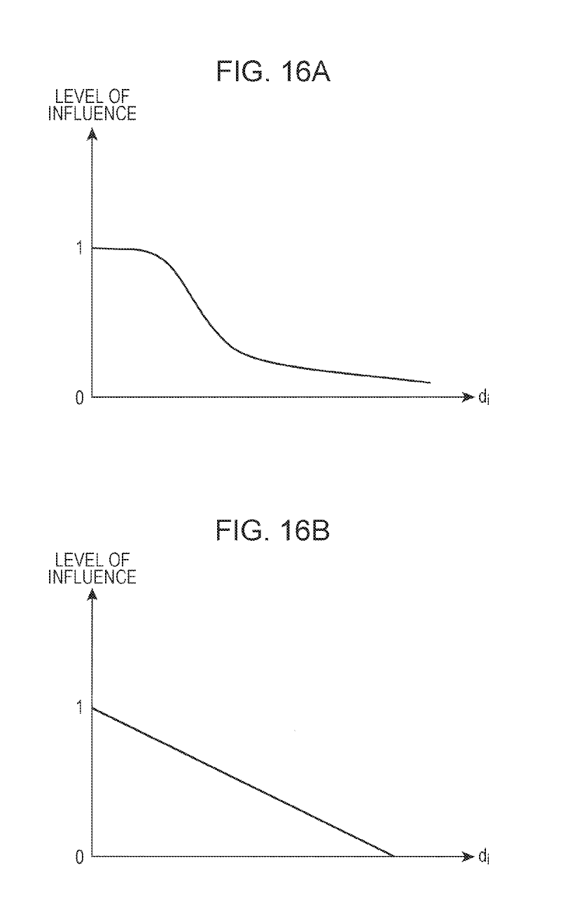

FIGS. 16A and 16B illustrate a method for determining a level of influence. In FIGS. 16A and 16B, the horizontal axis represents the Euclidean distance dᵢ and the vertical axis represents the level of influence.

The Euclidean distance dᵢ is a Euclidean distance dᵢ between the pixel value of a pixel given a strength and the pixel value of a neighboring pixel of the pixel. For example, as illustrated in FIG. 16A, a non-linear monotonically decreasing function is defined, and a value determined by the monotonically decreasing function with respect to a Euclidean distance dᵢ is defined as a level of influence.

That is, the smaller the Euclidean distance dᵢ, the higher the level of influence, and the larger the Euclidean distance dᵢ, the lower the level of influence.

The monotonically decreasing function is not limited to that illustrated in FIG. 16A, and a monotonically decreasing function with any shape may be used. Thus, a linear monotonically decreasing function illustrated in FIG. 16B may be used. Alternatively, a piecewise-linear monotonically decreasing function with a linear partition within a specific range of Euclidean distances dᵢ and a non-linear partition within the other range may be used.

The strength of a pixel determined to belong to an extracted region is obtained by multiplying the strength of the reference pixel by a level of influence. For example, the reference pixel has a strength of 1 and the level of influence of the reference pixel on a target pixel adjacent left to the reference pixel is 0.9. In this case, the strength given to the target pixel when the target pixel is determined to belong to the corresponding extracted region is given by 1×0.9=0.9. For example, the reference pixel has a strength of 1 and the level of influence of the reference pixel on a target pixel which is two pixels adjacent left to the reference pixel is 0.8. In this case, the strength given to the target pixel when the target pixel is determined to belong to the corresponding extracted region is given by 1×0.8=0.8.

Using the computation method described above, the determination unit 133 may perform the determination by using the strength given to the target pixel (first target pixel) within the first range. If the target pixel has no label, the determination unit 133 determines that the target pixel is included in the extracted region to which the reference pixel belongs. If the target pixel has a label for a different extracted region, the determination unit 133 determines that the target pixel is included in one of the extracted regions associated with a higher strength. In the former case, the same label as that of the reference pixel is assigned. In the latter case, the label corresponding to a higher strength among the characteristics is assigned. In this method, a pixel once labeled with a certain label may have the label changed to another label.

For instance, the target pixel (first target pixel) has been labeled with a certain label. If a reference pixel assigned a different label has a strength uᵢ and a level of influence wᵢⱼ, a strength uⱼ exerted on the target pixel (first target pixel) is given by uⱼ=wᵢⱼuᵢ. Then, the current strength of the target pixel (first target pixel) is compared with the strength uⱼ. If the strength uⱼ is higher than the strength of the target pixel (first target pixel), the target pixel (first target pixel) has the label changed to the different label. If the strength uⱼ is equal to or lower than the strength of the target pixel (first target pixel), the target pixel (first target pixel) does not have the label changed to the different label so that the current label is maintained.

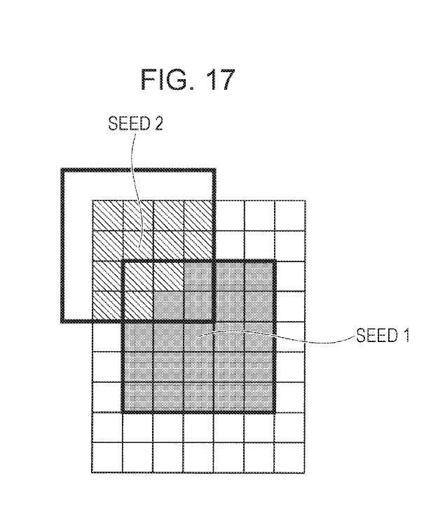

FIG. 17 illustrates a result of determination using a method based on strength for a target pixel within the first range illustrated in FIG. 14.

In FIG. 14, the first ranges for the pixels with seed 1 and seed 2 partially overlap. Unlabeled pixels in a portion where the first ranges do not overlap, that is, in a portion where the pixels with seed 1 and seed 2 do not interfere with each other, are all labeled with the same label as the corresponding one of the pixels with seed 1 and seed 2 serving as the reference pixel. On the other hand, pixels in a portion where the first ranges for the pixels with seed 1 and seed 2 overlap, that is, in a portion where the pixels with seed 1 and seed 2 interfere with each other, are each labeled with one of the labels corresponding to a higher strength. Consequently, labeled pixels illustrated in FIG. 17 are obtained.

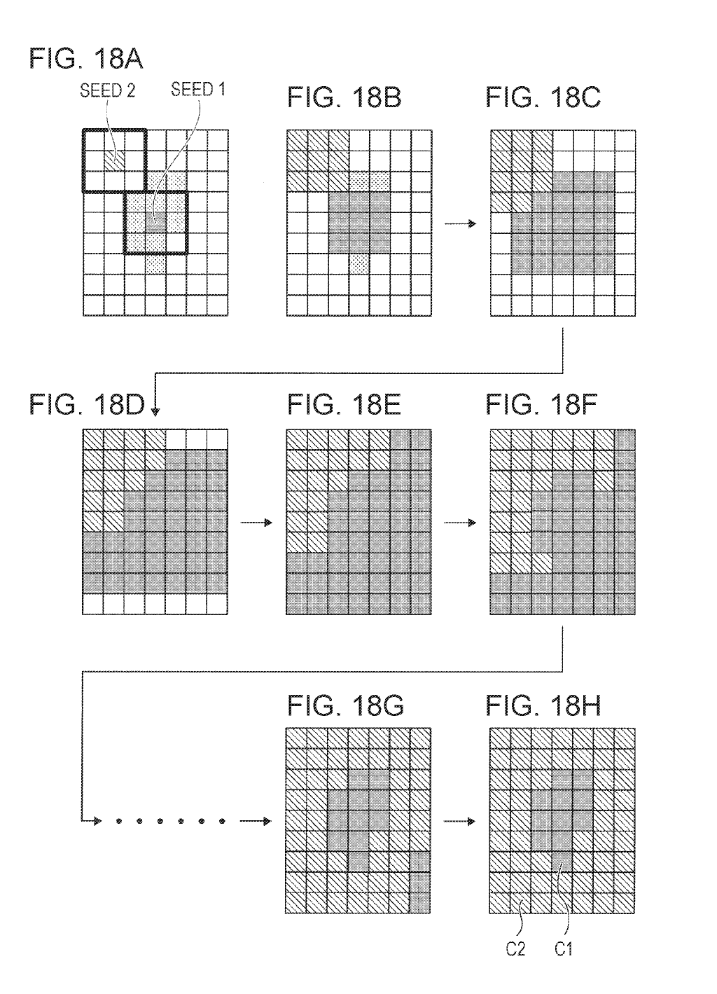

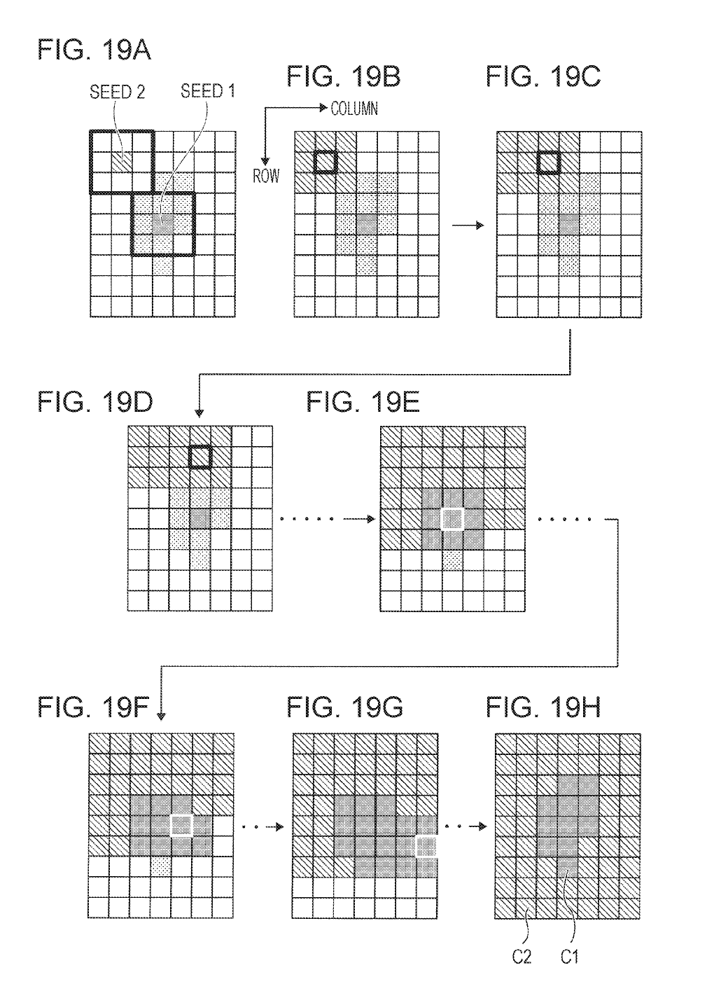

FIGS. 18A to 18H illustrate an example of the progress of how pixels are sequentially labeled by using a region growing method based on strength.

FIG. 18A illustrates a first range set in this case. That is, the pixels with seed 1 and seed 2, which are reference pixels, are selected in the image region R1 and the image region R2, respectively. In addition, ranges of 3 pixels vertically and 3 pixels horizontally centered respectively on the pixels with seed 1 and seed 2 are set as first ranges. In FIG. 18A, the first ranges are displayed in thick-line frames.

FIG. 18B illustrates a result of determination on the target pixels within the first ranges for the pixels with seed 1 and seed 2. Since the first ranges for the pixels with seed 1 and seed 2 do not overlap, the target pixels within each of the first ranges are all labeled with the same label as that of the corresponding reference pixel, namely, the pixel with seed 1 or seed 2.

FIG. 18C illustrates the result of an update by further region growing. As in FIG. 17, pixels in a portion where the first ranges for the pixels with seed 1 and seed 2 do not overlap are all labeled with the same label as that of the corresponding one of the pixels with seed 1 and seed 2 serving as the reference pixel. Further, pixels in a portion where the first ranges for the pixels with seed 1 and seed 2 overlap are each labeled with one of the labels corresponding to a higher strength.

Further, even a target pixel which has been labeled with a certain label is labeled with a label corresponding to the higher one of the current strength of the target pixel and the strength exerted by the reference pixel. In addition, a higher strength is given to the target pixel. That is, the label and strength of the target pixel are changed.

The labeled target pixel is now selected as a new reference pixel, and the image regions are sequentially updated in a manner illustrated in FIGS. 18D to 18H. Finally, as illustrated in FIG. 18H, the extracted region C1 and the extracted region C2 are segmented.

In the way described above, if it is determined that a target pixel belongs to an extracted region, the characteristic changing unit 134 changes the label and strength of the target pixel.

In practice, information on the label, the strength, and the level of influence is stored in a main memory 92 described below (see FIG. 28) or the like as information for each pixel. The information is read from the main memory 92 as necessary, and is updated when the label, the strength, and/or the level of influence is changed. This may improve the processing speed of the region extraction unit 13.

The process of the pixel selection unit 131, the range setting unit 132, the determination unit 133, and the characteristic changing unit 134, described above, is repeatedly performed until convergence is achieved. That is, as described with reference to FIG. 12, a pixel which is newly determined to belong to the extracted region C1 or the extracted region C2 is selected as a new reference pixel, and a specific range around the newly selected reference pixel is set as a first range again. Further, it is determined again whether or not a target pixel within the first range which has been set again belongs to the extracted region C1 or the extracted region C2. This process is repeatedly performed for a region update operation, thereby enabling a region subjected to the change of characteristics, such as labeling, to be expanded sequentially. Accordingly, the extracted region C1 and the extracted region C2 are segmented. This process may be equivalent to a process of performing determination plural times while selecting a reference pixel and sequentially changing the setting of a first range to detect extracted regions. In this method (region growing method), a pixel labeled with a certain label may also have the label changed to a different label.

The convergence determination unit 135 determines whether or not the series of processes described above has converged.

The convergence determination unit 135 determines that the series of processes has converged when, for example, there is no longer a pixel whose label is to be changed. Alternatively, a maximum number of updates may be determined in advance, and the convergence determination unit 135 may determine that the series of processes has converged when the maximum number of updates is reached.

In the region growing method in the first example described above, a target pixel to be determined to be or not to be in an extracted region is a pixel that belongs to a first range and that is not the pixel with seed 1 or seed 2 serving as a reference pixel. Then, the pixel value of the target pixel is compared with the pixel value of the reference pixel, and an extracted region to which the target pixel belongs is determined. That is, the region growing method in the first example is a so-called “active type” method in which the target pixel changes upon being influenced by the reference pixel.

In this region growing method, furthermore, the labels and strengths of the entire image immediately before region growing are temporarily stored. The determination unit 133 determines to which extracted region a target pixel within a first range set by using a reference pixel selected from within each extracted region belongs, and region growing is carried out. After the determination, the characteristic changing unit 134 changes the stored labels and strengths. The changed labels and strengths are stored as the labels and strengths of the entire image immediately before further region growing, and region growing is carried out again. In this case, the labels and strengths of the entire image are changed together. That is, the region growing method in the first example is a so-called “synchronous type” region growing method.

In this region growing method, furthermore, the first range may be fixed or changed. The first range may be changed so as to be reduced in accordance with the number of updates. Specifically, for example, the first range is initially set to be large, and is then reduced if the number of updates is greater than or equal to a certain specified value. Plural specified values may be set and the first range may be reduced stepwise. That is, setting the first range to be large in the initial stage may result in an increase in processing speed. Thereafter, setting the first range to be small when the update proceeds to some extent may result in a further improvement in the accuracy of separation of extracted regions. That is, an improvement in processing speed and an improvement in the accuracy of segmentation of extracted regions are concurrently achievable.

### Second Example (in the Case of “Active Type” and “Asynchronous Type”)

Next, a description will be given of a second example of the region extraction unit 13.

FIGS. 19A to 19H illustrate an example of the progress of how pixels are sequentially labeled by using a region growing method in the second example.

Similarly to FIG. 18A, FIG. 19A illustrates a first range set in this case.

In the second example, as illustrated in FIG. 19B, the determination unit 133 determines to which extracted region a target pixel within the first range belongs, starting with the pixel with seed 2, which is set at the second row and second column. Then, as illustrated in FIGS. 19C and 19D, the determination unit 133 determines to which extracted region a target pixel within the first range belongs while shifting the reference pixel to the right in FIGS. 19C and 19D by one pixel. This determination may be based on, for example, as described above, the degree of closeness of pixel values and may be performed by using equations (13) to (15). As in FIGS. 18A to 18H, this determination may also use a method based on strength.

After the determination for each of the pixels up to the right end in FIGS. 19C and 19D as a target pixel, the determination unit 133 shifts the reference pixel to the third row, and determines to which extracted region a target pixel within the first range belongs while shifting the reference pixel to the right in FIGS. 19C and 19D by one pixel in a similar manner. After the determination for each of the pixels up to the right end in FIGS. 19C and 19D as a target pixel, the determination unit 133 further shifts the reference pixel to the next row. This operation is repeatedly performed in the way illustrated in FIGS. 19E to 19G, and is performed until the reference pixel has moved to the lower right end in FIGS. 19E to 19G. In other words, the determination unit 133 may perform the determination while shifting the reference pixel so as to scan the image on a pixel-by-pixel basis.

After the reference pixel has reached the lower right end and becomes no longer movable, the determination unit 133 shifts the reference pixel in a direction opposite to that described above, and performs a similar process until the reference pixel has moved to the upper left end. Accordingly, a single reciprocating movement of the reference pixel is achieved. This reciprocating movement of the reference pixel is subsequently repeated until convergence is achieved.

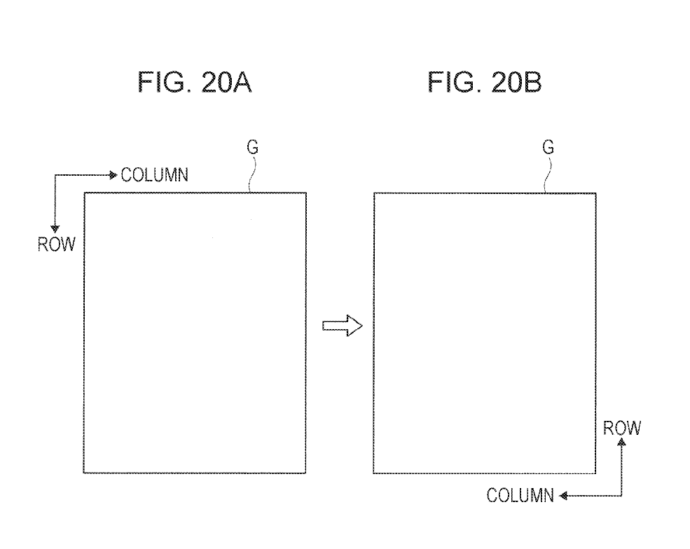

In other words, as illustrated in FIGS. 20A and 20B, a similar process is performed by reversing the order of rows and columns. Additionally, when reaching a terminal position (in this case, the lower right end or the upper left end), the reference pixel is further shifted so that the image is scanned in the reverse direction.

In the illustrated example, the description has been made in the context of a single starting point. Plural starting points may be set and individually shifted. In addition, any pixel in the image may be selected as a starting point.

Furthermore, even in a case where a single starting point is used, the reference pixel may be shifted so that the image is again scanned from the upper left end after the reference pixel has reached the lower right end. Alternatively, the reference pixel may be shifted so that the image is randomly scanned.

Finally, as illustrated in FIG. 19H, the extracted region C1 and the extracted region C2 are segmented.

In the second example, the operation of the components other than the determination unit 133, namely, the pixel selection unit 131, the range setting unit 132, the characteristic changing unit 134, and the convergence determination unit 135, is similar to that in the first example. Also, the first range may be fixed or changed. The first range may be changed so as to be reduced in accordance with the number of updates.

In this region growing method, each time a selected reference pixel is shifted by one pixel, the determination unit 133 determines to which extracted region a target pixel within the first range belongs, and region growing is carried out. This process may be equivalent to a process in which, after determining whether or not each of pixels included in a first range only for a selected reference pixel belongs to an extracted region, the determination unit 133 further selects a new reference pixel, and again sets a first range and performs determination to detect an extracted region. After the determination, the characteristic changing unit 134 changes the stored label and strength. In this case, the labels and strengths of the entire image are not changed together, and only a target pixel (first target pixel) within a first range determined each time the reference pixel is shifted by one pixel is to be subjected to the change in the label and strength. Thus, the region growing method in the second example is a so-called “asynchronous type” region growing method. In the “synchronous type” region growing method as in the first example, in response to a single selection of a reference pixel, the labels and strengths of the entire image are changed together on the basis of the labels and strengths of the immediately preceding image. In this sense, such a region growing method is referred to herein as that of a “synchronous type”. In other words, the state transition (in terms of label and strength) switches relatively slowly. In the second example, unlike the “synchronous type”, only the label and strength of a target pixel (first target pixel) that is a single pixel are changed in response to a single selection of a reference pixel. That is, the labels or strengths of pixels other than the target pixel (first target pixel) are not changed. In this sense, such a region growing method is referred to herein as that of an “asynchronous type”. Thereafter, a reference pixel is again selected, and only a pixel within a first range is used as a target pixel. This operation is repeatedly performed, allowing the state transition (in terms of label and strength) to switch more rapidly than that in the synchronous type.

Next, a description will be given of the operation of the region extraction unit 13 in the first and second examples.

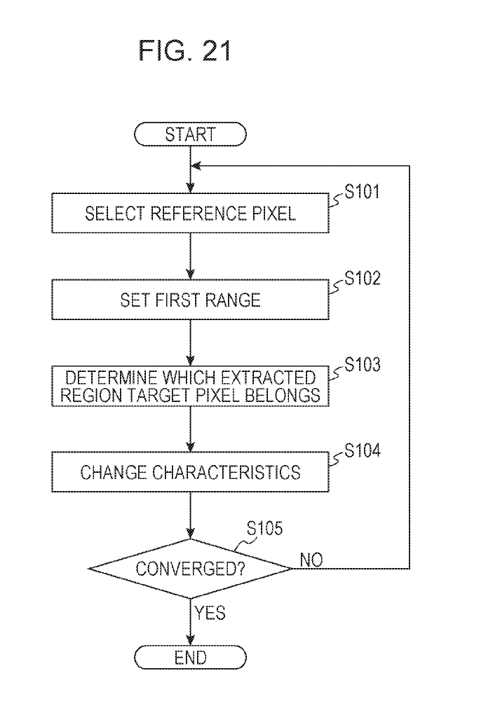

FIG. 21 is a flowchart illustrating the operation of the region extraction unit 13 in the first and second examples.

In the following, the operation of the region extraction unit 13 will be described with reference to FIG. 12 and FIG. 21.

First, the pixel selection unit 131 selects a reference pixel to be selected from among pixels belonging to an extracted region (step S101). In the example illustrated in FIG. 13B, the pixel selection unit 131 selects the pixels with seed 1 and seed 2 as reference pixels.

Then, the range setting unit 132 sets a first range for the reference pixel, which is a range for a target pixel (first target pixel) to be determined to be or not to be in the corresponding extracted region (step S102). In the example illustrated in FIG. 13B, the range setting unit 132 sets, as first ranges, ranges of 5 pixels vertically and 5 pixels horizontally centered respectively on the pixels with seed 1 and seed 2.

Then, the determination unit 133 determines to which extracted region the target pixel within the first range belongs (step S103). In this case, the determination unit 133 determines that the target pixel belongs to an extracted region associated with a higher strength in a portion where extracted regions interfere with each other. Alternatively, the determination unit 133 may perform the determination based on the Euclidean distance dᵢ of the pixel values, and may spread the extracted region.

Further, the characteristic changing unit 134 changes the characteristics of a target pixel determined by the determination unit 133 to belong to any of the extracted regions (step S104). Specifically, the characteristic changing unit 134 labels such a target pixel, and further gives a strength to the target pixel.

Then, the convergence determination unit 135 determines whether or not the series of processes has converged (step S105). The convergence determination unit 135 may determine that the series of processes has converged when, as described above, there is no longer a pixel whose label is to be changed or the predetermined maximum number of updates is reached.

If the convergence determination unit 135 determines that the series of processes has converged (YES in step S105), the extracted region segmentation process ends.

On the other hand, if the convergence determination unit 135 determines that the series of processes has not converged (NO in step S105), the process returns to step S101. In this case, the reference pixel selected by the pixel selection unit 131 is changed.

### Third Example (in the Case of “Passive Type” and “Synchronous Type”)

Next, a description will be given of a third example of the region extraction unit 13.

In the third example, the pixel selection unit 131 selects one target pixel to be determined to be or not to be in an extracted region. The range setting unit 132 changes a second range. The second range is set for the selected target pixel (second target pixel), and is a range including a reference pixel for determining in which extracted region the selected target pixel is included.

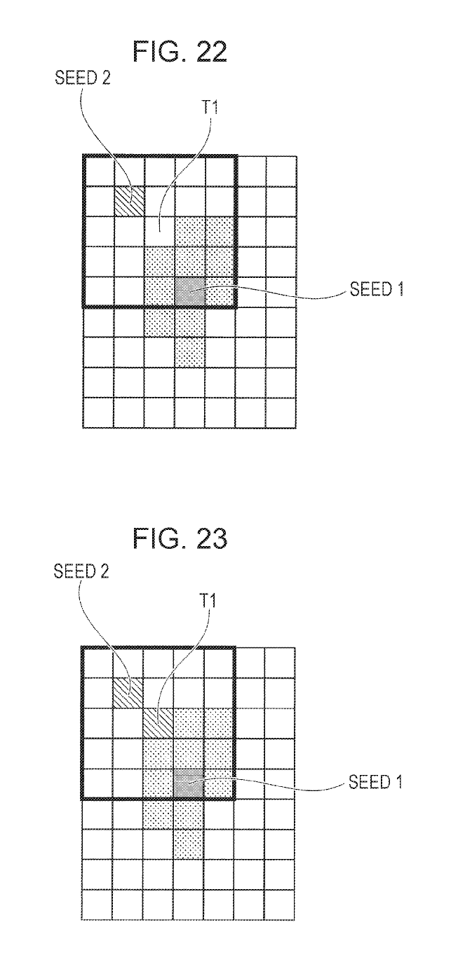

FIG. 22 illustrates a target pixel selected by the pixel selection unit 131 and a second range set by the range setting unit 132.

In FIG. 22, as in FIG. 13B, the pixels with seed 1 and seed 2 are set as reference pixels in the original image illustrated in FIG. 13A. One pixel denoted by T1 is selected as a target pixel (second target pixel). In addition, a range of 5 pixels vertically and 5 pixels horizontally centered on the target pixel T1 is set as a second range. In FIG. 22, the second range is displayed in a thick-line frame.

The determination unit 133 determines to which extracted region the target pixel T1 belongs. The determination unit 133 determines whether the target pixel T1 belongs to an extracted region (the extracted region C1) to which the pixel with seed 1 belongs or an extracted region (the extracted region C2) to which the pixel with seed 2 belongs.

The determination unit 133 determines whether the target pixel T1 belongs to the extracted region C1 or the extracted region C2 by, for example, determining which of the pixel values of the pixels with seed 1 and seed 2 serving as reference pixels included in the second range the pixel value of the target pixel T1 is closer to. That is, the determination unit 133 performs the determination in accordance with the degree of closeness of the pixel value of the target pixel T1 to the pixel value of each of the reference pixels.

Alternatively, the determination unit 133 may perform the determination by using a method based on strength. In this case, the determination unit 133 determines whether or not the target pixel T1 (second target pixel) belongs to an extracted region, by using the strengths of the reference pixels included in the second range.

FIG. 23 illustrates a result of the determination according to the third example.

In FIG. 23, the pixel value of the target pixel T1 is closer to the pixel value of the pixel with seed 2 than to the pixel value of the pixel with seed 1, and it is thus determined that the target pixel T1 belongs to the extracted region C2.

The operation of the characteristic changing unit 134 and the convergence determination unit 135 is similar to that in the first example.

Also in the third example, the process of the pixel selection unit 131, the range setting unit 132, the determination unit 133, and the characteristic changing unit 134 is repeatedly performed until convergence is achieved. This process is repeatedly performed for a region update operation, thereby enabling a region subjected to the change of characteristics, such as labeling, to be expanded sequentially. Accordingly, the extracted region C1 and the extracted region C2 are segmented. The second range is variable and may be reduced sequentially in accordance with the number of updates.

Specifically, the second range is initially set to be large, and is then reduced if the number of updates is greater than or equal to a certain specified value. Plural specified values may be set and the second range may be reduced stepwise. That is, the second range is set to be large in the initial stage so that reference pixels are more likely to be present within the second range, resulting in more efficient determination. Further, setting the second range to be small when the update proceeds to some extent may result in an improvement in the accuracy of separation of extracted regions.

The region growing method according to the third example focuses on the target pixel T1, and the pixel value of the target pixel T1 is compared with the pixel value of each of reference pixels (the pixels with seed 1 and seed 2) within the second range to determine the extracted region to which the target pixel T1 belongs. That is, the region growing method in the third example is a so-called “passive type” method in which the target pixel T1 changes upon being influenced by a reference pixel within the second range.

Also in the passive-type method, a pixel labeled with a certain label may have the label changed to a different label.

This method is similar to the region growing method of the related art described with reference to FIGS. 11A to 11C. In the region growing method of the related art, the target pixel T1 is influenced by eight fixed neighboring pixels adjacent to the target pixel T1. In contrast, the region growing method in the third example has a feature in that the second range is variable. The second range having a larger size may enable more efficient determination, as described above. Eight fixed neighboring pixels, on the other hand, will be less likely to include a reference pixel, resulting in low efficiency of determination.

In this region growing method, furthermore, the labels and strengths of the entire image immediately before region growing are temporarily stored. Then, the determination unit 133 determines to which extracted region the selected target pixel T1 belongs, and region growing is carried out. After the determination, the characteristic changing unit 134 changes the stored labels and strengths. The changed labels and strengths are stored as the labels and strengths of the entire image immediately before further region growing, and region growing is carried out again. That is, the region growing method in the third example is of a so-called “synchronous type”.

In addition, reducing the size of the second range may further improve the accuracy of separation of extracted regions. In the third example, accordingly, the second range is changed so as to be reduced in accordance with the number of updates.

### Fourth Example (in the Case of “Passive Type” and “Asynchronous Type”)

The region growing method described above is of the “synchronous type” as in the first example. Alternatively, the region growing method of the “asynchronous type” as in the second example may be used. In the following, the region growing method of the “passive type” and the “asynchronous type” will be described as a fourth example.

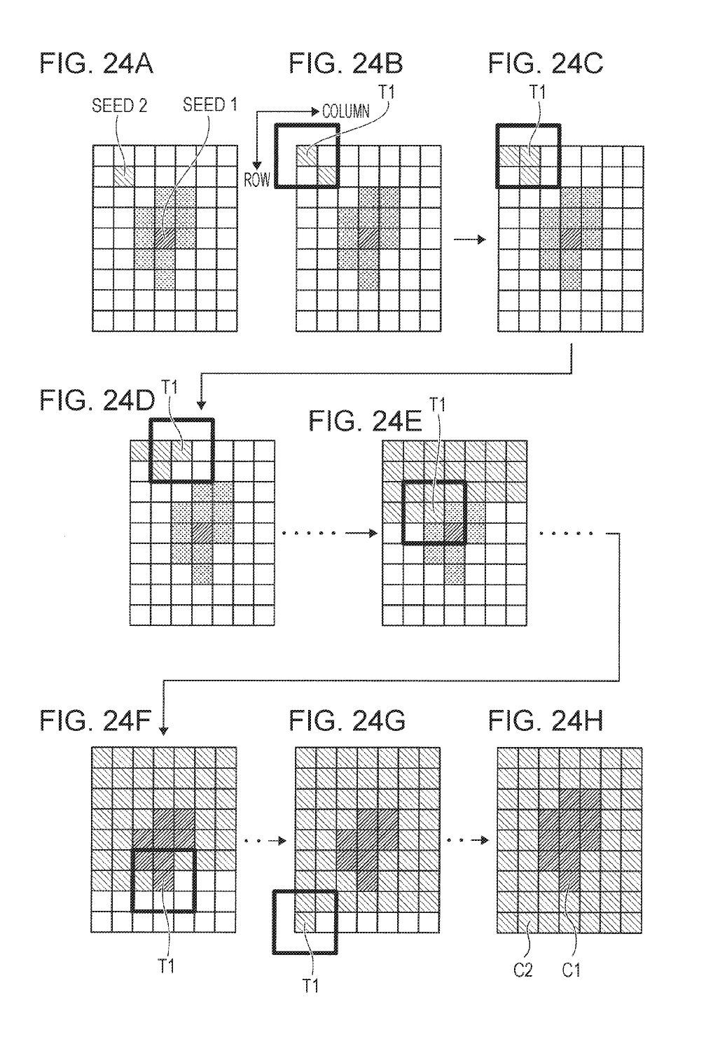

FIGS. 24A to 24H illustrate an example of the progress of how pixels are sequentially labeled by using a region growing method in the fourth example.

In FIG. 24A, the pixels with seed 1 and seed 2 serving as reference pixels illustrated in FIG. 13B are set in the original image illustrated in FIG. 13A, which is similar to that described with reference to FIGS. 18A and 19A.

FIG. 24B illustrates a second range set in this case. In the fourth example, as illustrated in FIG. 24B, the determination unit 133 sets the pixel at the first row and first column as the starting point, and initially sets this pixel as a target pixel T1. Then, the determination unit 133 determines to which extracted region the target pixel T1 belongs. Then, as illustrated in FIGS. 24C and 24D, the determination unit 133 determines to which extracted region the target pixel T1 belongs, while shifting the target pixel T1 to the right in FIGS. 24C and 24D by one pixel. This determination is based on strength, and is similar to that in the first to third examples.

After the determination for each of the pixels up to the right end in FIGS. 24C and 24D as a target pixel T1, the determination unit 133 shifts the target pixel T1 to the second row, and determines to which extracted region the target pixel T1 belongs while shifting the target pixel T1 to the right in FIGS. 24C and 24D by one pixel in a manner similar to that described above. After the determination for the pixels up to the right end in FIGS. 24C and 24D, the determination unit 133 further shifts the target pixel T1 to the next row. This operation is repeatedly performed in the way illustrated in FIGS. 24E to 24G, and is performed until the target pixel T1 has moved to the lower right end in FIGS. 24E to 24G.

After the target pixel T1 has reached the lower right end and becomes no longer movable, the determination unit 133 shifts the target pixel T1 in a direction opposite to that described above, and performs a similar process until the target pixel T1 has moved to the upper left end. Accordingly, a single reciprocating movement of the target pixel T1 is achieved. This reciprocating movement of the target pixel T1 is subsequently repeated until convergence is achieved.

In the illustrated example, the description has been made in the context of a single starting point. Alternatively, as described in the second example, plural starting points may be set and individually shifted. In addition, any pixel in the image may be selected as a starting point.

Finally, as illustrated in FIG. 24H, the extracted region C1 and the extracted region C2 are segmented.

This region growing method may also provide a high convergence speed and a high processing speed. When reaching a terminal position, the target pixel T1 is further shifted so that the image is scanned in the reverse direction, allowing a portion with slow convergence to be less likely to occur, resulting in a higher convergence speed.

The second range may be fixed or changed. The second range may be changed so as to be reduced in size in accordance with the number of updates.

In this region growing method, furthermore, each time the selected target pixel T1 is shifted by one pixel, the determination unit 133 determines to which extracted region the target pixel T1 belongs, and region growing is carried out. That is, a single target pixel T1 (second target pixel) is selected in a predetermined order, and a selected target pixel T1 (second target pixel) is subjected to a determination once. This determination is repeatedly performed. This process may be equivalent to a process in which, after determining whether or not a target pixel T1 (second target pixel) selected by using a pixel included in an extracted region as a reference pixel belongs to the extracted region, the determination unit 133 further selects a new target pixel T1 (second target pixel), and again sets a second range and performs determination to detect an extracted region. After the determination, the characteristic changing unit 134 changes the stored label and strength. That is, only the target pixel T1 (second target pixel) is to be subjected to the change in the label and strength each time the target pixel T1 is shifted by one pixel. The region growing method described above is of an “asynchronous type”.

In the third and fourth examples, the determination unit 133 selects a target pixel T1 (second target pixel), and determines whether or not the target pixel T1 (second target pixel) belongs to an extracted region to which a reference pixel within the second range belongs. This determination is performed multiple times while selecting a target pixel T1 (second target pixel) and sequentially changing the second range set accordingly. In addition, as described above, this determination is performed based on the degree of closeness of the pixel value of the target pixel T1 to the pixel value of the reference pixel and by comparing the strength of the target pixel T1 with that of the reference pixel. Accordingly, the label of the target pixel T1 (second target pixel) is changed. In this case, the target pixel T1 (second target pixel) is influenced by a reference pixel located near the target pixel T1 (second target pixel), and the label of the target pixel T1 (second target pixel) is changed accordingly. In this sense, such a region growing method is referred to herein as that of a “passive type”.

Next, a description will be given of the operation of the region extraction unit 13 in the third and fourth examples.

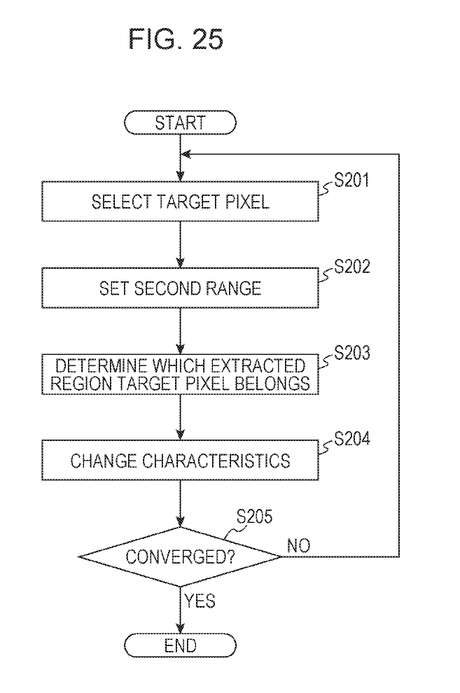

FIG. 25 is a flowchart illustrating the operation of the region extraction unit 13 in the third and fourth examples.

In the following, the operation of the region extraction unit 13 will be described FIG. 12 and FIG. 25.

First, the pixel selection unit 131 selects a target pixel (second target pixel) (step S201). In the example illustrated in FIG. 22, the pixel selection unit 131 selects a target pixel T1.

Then, the range setting unit 132 sets a second range for the target pixel T1, which is an influential range of pixels having an effect on determination (step S202). In the example illustrated in FIG. 22, the range setting unit 132 sets, as the second range, a range of 5 pixels vertically and 5 pixels horizontally centered on the target pixel T1.

Then, the determination unit 133 determines to which extracted region the target pixel T1 belongs (step S203). In the example described above, the determination unit 133 performs the determination in accordance with the degree of closeness of the pixel value of the target pixel T1 to each of the pixel values of the pixels with seed 1 and seed 2 and in accordance with the strengths of the target pixel T1 and the pixels with seed 1 and seed 2.

If the determination unit 133 determines that the target pixel T1 belongs to any of the extracted regions, the characteristic changing unit 134 changes the characteristics (step S204). Specifically, the characteristic changing unit 134 labels the target pixel T1, and further gives a strength to the target pixel T1.

Then, the convergence determination unit 135 determines whether or not the series of processes has converged (step S205). The convergence determination unit 135 may determine that the series of processes has converged when, as described above, there is no longer a pixel whose label is to be changed or the predetermined maximum number of updates is reached.

If the convergence determination unit 135 determines that the series of processes has converged (YES in step S205), the extracted region segmentation process ends.

On the other hand, if the convergence determination unit 135 determines that the series of processes has not converged (NO in step S205), the process returns to step S201. In this case, the target pixel (second target pixel) selected by the pixel selection unit 131 is changed.

### Fifth Example (in the Case of Using Both “Active Type” and “Passive Type”)

Next, a description will be given of a fifth example of the region extraction unit 13.

The fifth example adopts both the “active type” region growing method described in the first and second examples and the “passive type” region growing method described in the third and fourth examples. That is, in the fifth example, region growing is carried out while the “active type” region growing method and the “passive type” region growing method are switched during the update.

The range setting unit 132 selects which of the “active type” region growing method and the “passive type” region growing method to use each time an update is performed. If the “active type” region growing method is selected, the range setting unit 132 sets a first range. Then, the determination unit 133 determines to which extracted region a target pixel within the first range belongs. If the “passive type” region growing method is selected, the range setting unit 132 sets a second range. Then, the determination unit 133 determines to which extracted region a target pixel belongs. That is, the determination unit 133 performs determination while switching at least once between the setting of a first range and the setting of a second range.

The switching method may be performed in any way. For example, the “active type” and “passive type” region growing methods may be alternately used. Alternatively, the “active type” region growing method may be initially used a number of times corresponding to the predetermined number of updates, and then the “passive type” region growing method may be used until the end of the process. Conversely, the “passive type” region growing method may be initially used a number of times corresponding to the predetermined number of updates, and then the “active type” region growing method may be used until the end of the process. The “active type” region growing method in either the first and second examples may be used.

Accordingly, a region growing method that adopts both the “active type” and the “passive type” also enables the segmentation of the extracted region C1 and the extracted region C2.

In the fifth example, the first range or the second range to be set may be fixed or variable. The first range and the second range may be sequentially reduced in accordance with the number of updates. In addition, any region growing method may be used regardless of whether the region growing method is of the “synchronous type” as in the first or third example and the “asynchronous type” as in the second or fourth example.

Next, a description will be given of the operation of the region extraction unit 13 in the fifth example.

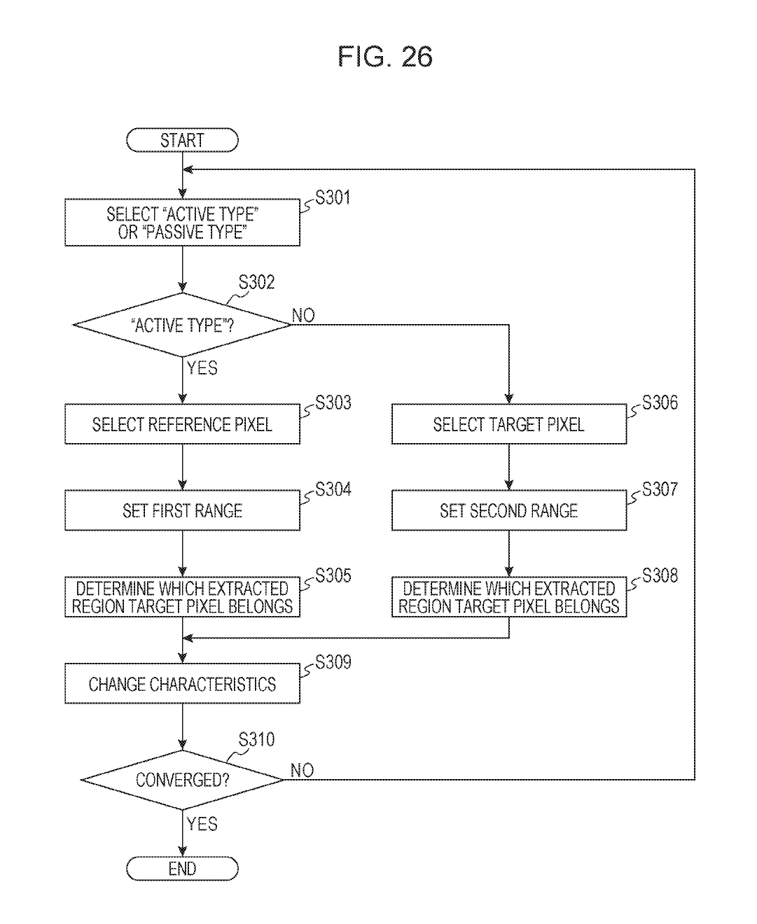

FIG. 26 is a flowchart illustrating the operation of the region extraction unit 13 in the fifth example.

In the following, the operation of the region extraction unit 13 will be described with reference to FIG. 12 and FIG. 26.

First, the pixel selection unit 131 selects which of the “active type” and the “passive type” to use (step S301).

If the pixel selection unit 131 selects the “active type” (YES in step S302), the pixel selection unit 131 selects a reference pixel to be selected from among pixels belonging to an extracted region (step S303).

Then, the range setting unit 132 sets a first range for the reference pixel, which is a range for a target pixel (first target pixel) to be determined to be or not to be in the corresponding extracted region (step S304).

Then, the determination unit 133 determines to which extracted region the target pixel within the first range belongs (step S305).

On the other hand, if the pixel selection unit 131 selects the “passive type” (NO in step S302), the pixel selection unit 131 selects a target pixel T1 (second target pixel) (step S306).

Then, the range setting unit 132 sets a second range for the target pixel T1, which is an influential range of pixels having an effect on determination (step S307).

Then, the determination unit 133 determines to which extracted region the target pixel T1 belongs (step S308).

Then, the characteristic changing unit 134 changes the characteristics of the target pixel within the first range or the target pixel T1, which is determined by the determination unit 133 to belong to any of the extracted regions (step S309).

Then, the convergence determination unit 135 determines whether or not the series of processes has converged (step S310).

If the convergence determination unit 135 determines that the series of processes has converged (YES in step S310), the extracted region segmentation process ends.

On the other hand, if the convergence determination unit 135 determines that the series of processes has not converged (NO in step S310), the process returns to step S301. In this case, the reference pixel or the target pixel T1 (second target pixel) selected by the pixel selection unit 131 is changed.

If an image obtained by the image information obtaining unit 11 has low visibility, retinex processing or the like may be performed in advance to enhance visibility.

Assuming that the pixel value (luminance value) of a pixel at a pixel position (x, y) on an image is represented by I(x, y) and the pixel value of the corresponding pixel on a visibility-enhanced image is represented by I′ (x, y), retinex processing may enable an enhancement of visibility as follows.

I′(x,y)=αR(x,y)+(1−α)I(x,y),

where α is a parameter that emphasizes reflectance and R(x, y) denotes an estimated reflectance component. In a retinex model, the emphasis of the reflectance component may enable an enhancement in visibility. In the exemplary embodiments, the estimated reflectance component R(x, y) may be calculated by using any existing method using a retinex model. Given 0≦α≦1, the original image is represented when α=0 and the reflectance image (with maximum visibility) is represented when α=1. The parameter α may be adjusted by the user, or may be associated with a value in accordance with the darkness of the image.

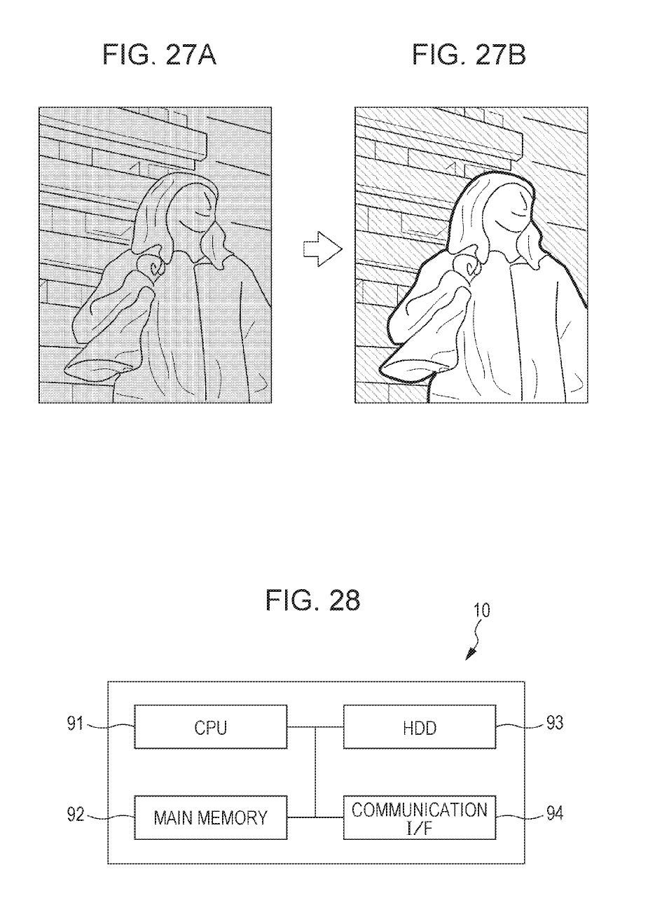

FIGS. 27A and 27B are conceptual diagrams illustrating retinex processing for enhancing the visibility of an original image.

FIG. 27A illustrates the original image, and FIG. 27B illustrates an image subjected to the retinex processing. In this manner, the enhancement of visibility may further improve the accuracy of segmentation of extracted regions.

Furthermore, the image processing apparatus 10 according to the exemplary embodiments described above first generates a seed (representative position), and then performs region growing based on the generated seed to extract an extracted region.

A process performed by the image processing apparatus 10 described above may be regarded as an image processing method including generating a representative position included in a region that is part of an image in accordance with a feature value indicating a feature of the image, extracting, based on the representative position, plural regions as candidate regions each having a feature value similar to the feature value of the representative position, and accepting, from a user, selection of at least one region from among the extracted plural regions.

### Example Hardware Configuration of Image Processing Apparatus

Next, a hardware configuration of the image processing apparatus 10 will be described.

FIG. 28 illustrates a hardware configuration of the image processing apparatus 10.

As described above, the image processing apparatus 10 is implementable by a personal computer or the like. As illustrated in FIG. 28, the image processing apparatus 10 includes a central processing unit (CPU) 91 serving as an arithmetic unit, and a main memory 92 and a hard disk drive (HDD) 93, each of which serves as a storage unit. The CPU 91 executes various programs such as an operating system (OS) and application software. The main memory 92 is a storage area that stores various programs and data and the like used for the execution of the programs, and the HDD 93 is a storage area that stores input data to various programs, output data from the various programs, and the like.

The image processing apparatus 10 further includes a communication interface (I/F) 94 for performing communication with an external device.

### Description of Program

The process performed by the image processing apparatus 10 according to the exemplary embodiments described above is prepared as, for example, a program of application software or the like.

Accordingly, a process performed by the image processing apparatus 10 in the exemplary embodiments may be regarded as a program for causing a computer to perform a representative position generation function of generating a representative position included in a region that is part of an image in accordance with a feature value indicating a feature of the image, a region extraction function of extracting, based on the representative position, plural regions as candidate regions each having a feature value similar to the feature value of the representative position, and a selection information acceptance function of accepting, from a user, selection of at least one region from among the extracted plural regions.

A program implementing the exemplary embodiments disclosed herein may be provided through a communication unit, or may be stored in a recording medium such as a compact disc read-only memory (CD-ROM) and provided.

While exemplary embodiments have been described, the technical scope of the present invention is not limited to the scope of the exemplary embodiments described above. It will be apparent from the appended claims that a variety of changes or modifications made to the exemplary embodiments described above also fall within the technical scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a representative position generation unit that generates a representative position included in a region that is part of an image in accordance with a feature value indicating a feature of the image;
a region extraction unit that extracts, based on the representative position, a plurality of regions as candidate regions each having a feature value similar to the feature value of the representative position; and
a selection information acceptance unit that accepts, from a user, selection of at least one region from among the extracted plurality of regions.

2. The image processing apparatus according to claim 1, further comprising an image smoothing unit that smooths the image,
wherein the representative position generation unit generates the representative position from the image smoothed by the image smoothing unit.

3. The image processing apparatus according to claim 1, further comprising a band division unit that divides the image into bands,
wherein the representative position generation unit generates the representative position from the image processed by the band division unit.

4. The image processing apparatus according to claim 1, wherein the feature value is at least one of a magnitude of a pixel value of each pixel constituting the image, a Euclidean distance between a chromaticity of each pixel constituting the image and a predetermined chromaticity, or a degree of visual attention.

5. The image processing apparatus according to claim 2, wherein the feature value is at least one of a magnitude of a pixel value of each pixel constituting the image, a Euclidean distance between a chromaticity of each pixel constituting the image and a predetermined chromaticity, or a degree of visual attention.

6. The image processing apparatus according to claim 3, wherein the feature value is at least one of a magnitude of a pixel value of each pixel constituting the image, a Euclidean distance between a chromaticity of each pixel constituting the image and a predetermined chromaticity, or a degree of visual attention.

7. The image processing apparatus according to claim 1, wherein the region extraction unit extracts the plurality of regions, based on the representative position, by using a region growing method.

8. The image processing apparatus according to claim 2, wherein the region extraction unit extracts the plurality of regions, based on the representative position, by using a region growing method.

9. The image processing apparatus according to claim 3, wherein the region extraction unit extracts the plurality of regions, based on the representative position, by using a region growing method.

10. The image processing apparatus according to claim 4, wherein the region extraction unit extracts the plurality of regions, based on the representative position, by using a region growing method.

11. The image processing apparatus according to claim 5, wherein the region extraction unit extracts the plurality of regions, based on the representative position, by using a region growing method.

12. The image processing apparatus according to claim 6, wherein the region extraction unit extracts the plurality of regions, based on the representative position, by using a region growing method.

13. An image processing method comprising:
generating a representative position included in a region that is part of an image in accordance with a feature value indicating a feature of the image;
extracting, based on the representative position, a plurality of regions as candidate regions each having a feature value similar to the feature value of the representative position; and
accepting, from a user, selection of at least one region from among the extracted plurality of regions.

14. An image processing system comprising:
a display device that displays an image;
an image processing apparatus that performs image processing on image information on the image displayed on the display device; and
an input device that receives instructions given by a user to the image processing apparatus to perform image processing,
the image processing apparatus including
a representative position generation unit that generates a representative position included in a region that is part of the image in accordance with a feature value indicating a feature of the image,
a region extraction unit that extracts, based on the representative position, a plurality of regions as candidate regions each having a feature value similar to the feature value of the representative position, and
a selection information acceptance unit that accepts, from the user, selection of at least one region from among the extracted plurality of regions.

15. A non-transitory computer readable medium storing a program causing a computer to execute a process for imaging processing, the process comprising:
generating a representative position included in a region that is part of an image in accordance with a feature value indicating a feature of the image;
extracting, based on the representative position, a plurality of regions as candidate regions each having a feature value similar to the feature value of the representative position; and
accepting, from a user, selection of at least one region from among the extracted plurality of regions.
